(19) United States
(12) Patent Application Publication
(10) Pub. No.: US 2022/0056327 A1
(43) Pub. Date: Feb. 24, 2022

(54) BONDED ABRASIVE ARTICLE PRECURSOR

(71) Applicant: 3M INNOVATIVE PROPERTIES COMPANY, St. Paul, MN (US)

(72) Inventors: Gregory P. Sorenson, Maplewood, MN (US); Melissa C. Schillo-Armstrong, Woodbury, MN (US); Brett A. Beiermann, St. Paul, MN (US)

(21) Appl. No.: 17/309,754

(22) PCT Filed: Dec. 16, 2019
(86) PCT No.: PCT/IB2019/060851

§ 371 Date: Jun. 17, 2021

Related U.S. Application Data
(60) Provisional application No. 62/780,961, filed on Dec. 18, 2018.

(51) Int. Cl. C09K 3/14; B24D 3/28; B24D 5/12; B24D 11/02; B24D 18/00

(52) U.S. Cl. CPC C09K 3/1409; B24D 3/28; B24D 2203/00; B24D 11/02; B24D 18/0072; B24D 5/12

(57) ABSTRACT

Various embodiments of the present disclosure provide a bonded abrasive article precursor (100). The bonded abrasive article precursor (100) includes an abrasive layer comprising a plurality of shaped abrasive particles (102) disposed on an adhesive (106) and forming a predetermined pattern.

### BACKGROUND

Abrasive particles and abrasive articles including the abrasive particles are useful for abrading, finishing, or grinding a wide variety of materials and surfaces in the manufacturing of goods. As such, there continues to be a need for improving the cost, performance, and ease of manufacturing abrasive articles.

### SUMMARY OF THE DISCLOSURE

Various embodiments of the present disclosure provide a bonded abrasive article precursor. The bonded abrasive article precursor includes an abrasive layer comprising a plurality of shaped abrasive particles disposed on an adhesive and forming a predetermined pattern.

Various embodiments of the present disclosure further provide a bonded abrasive article. The bonded abrasive article provides a first major surface and an opposed second major surface each contacting a peripheral side surface and extending in an x-y-direction. The bonded abrasive article includes a central axis extending through the first and second major surfaces in a z-direction. The bonded abrasive article further includes a bonded abrasive article precursor. The bonded abrasive article precursor includes an abrasive layer comprising a plurality of shaped abrasive particles disposed on an adhesive and forming a predetermined pattern. The bonded abrasive article further includes a binder material retaining the layer of abrasive particles.

Various embodiments of the present disclosure further provide a method of making a bonded abrasive article precursor. The bonded abrasive article precursor includes an abrasive layer comprising a plurality of shaped abrasive particles disposed on an adhesive and forming a predetermined pattern. The method includes contacting the plurality of shaped abrasive particles with the adhesive.

Various embodiments of the present disclosure further provide a method of forming a bonded abrasive article. The method includes positioning a bonded abrasive article precursor at least partially within a mold. The bonded abrasive article precursor includes an abrasive layer comprising a plurality of shaped abrasive particles disposed on an adhesive and forming a predetermined pattern. The method includes depositing a binder material in the mold and pressing the binder material.

Various embodiments of the present disclosure further provide a method of using a bonded abrasive article. The bonded abrasive article provides a first major surface and an opposed second major surface each contacting a peripheral side surface and extending in an x-y-direction. The bonded abrasive article includes a central axis extending through the first and second major surfaces in a z-direction. The bonded abrasive article further includes a bonded abrasive article precursor. The bonded abrasive article precursor includes an abrasive layer comprising a plurality of shaped abrasive particles disposed on an adhesive and forming a predetermined pattern. The bonded abrasive article further includes a binder material retaining the layer of abrasive particles. The method includes moving the abrasive article with respect to a surface contacted therewith, to abrade the surface.

There are various reasons to use the bonded abrasive article precursor of the present disclosure, including the following non-limiting reasons. For example, according to various embodiments, the bonded abrasive article precursor can help to ensure that a bonded abrasive article to which the bonded abrasive article precursor is incorporated can reliably replicate a desired predetermined pattern.

### BRIEF DESCRIPTION OF THE FIGURES

The drawings illustrate generally, by way of example, but not by way of limitation, various embodiments discussed in the present document.

FIG. 1A is a perspective view of a bonded abrasive article precursor, in accordance with various embodiments.

FIG. 1B is a perspective view of a bonded abrasive article precursor in which shaped abrasive particles are rotated 90 degrees about a z-axis relative to those shown in FIG. 1A, in accordance with various embodiments.

FIGS. 2A and 2B show shaped abrasive particles having a truncated regular trigonal pyramid shape, in accordance with various embodiments.

FIGS. 3A-3E show various embodiments of tetrahedral shaped abrasive particles, in accordance with various embodiments.

FIG. 4 shows a cylindrical shaped abrasive particle, in accordance with various embodiments.

FIG. 5 shows a bowtie shaped abrasive particle, in accordance with various embodiments.

FIG. 6 shows an elongated shaped abrasive particle, in accordance with various embodiments.

FIG. 7 shows another embodiment of an elongated shaped abrasive particle, in accordance with various embodiments.

FIG. 8 is a sectional perspective view of an apparatus for making the bonded abrasive article precursor according to various embodiments.

FIG. 9 is another sectional perspective view of the apparatus for making the bonded abrasive article precursor according to various embodiments.

FIG. 10 is a perspective view of a bonded abrasive article, in accordance with various embodiments.

FIG. 11 is a sectional view of the bonded abrasive article of FIG. 10 taken along line 2-2, in accordance with various embodiments.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

According to various embodiments of the present invention, a bonded abrasive article precursor can include a plurality of shaped abrasive particles disposed about or embedded into an adhesive (e.g., a pressure-sensitive adhesive including a thermoplastic, thermosetting, or radiation curable resin) and forming a predetermined pattern thereon. The bonded abrasive article precursor can be used in forming a bonded abrasive article in that the bonded abrasive precursor can be disposed within a mold and at least partially immersed in a binder material to form a bonded abrasive article. Using the bonded abrasive article precursor can help to ensure that the desired predetermined pattern of shaped abrasive particles is present in the bonded abrasive article. Moreover, using multiple bonded abrasive article precursors in constructing a bonded abrasive article can be useful to form layers of shaped abrasive particles, each layer having a predetermined pattern in the bonded abrasive article. Additionally, it can be possible to position adjacent bonded abrasive article precursors in the binder material such that each adjacent layer of shaped abrasive particles is staggered with respect to each other. This can ultimately form a spiral pattern of shaped abrasive particles in the bonded abrasive article.

As used herein, “shaped abrasive particle” means an abrasive particle having a predetermined or non-random shape. One process to make a shaped abrasive particle, such as a shaped ceramic abrasive particle, includes shaping the precursor ceramic abrasive particle in a mold having a predetermined shape to make ceramic shaped abrasive particles. Ceramic shaped abrasive particles, formed in a mold, are one species in the genus of shaped ceramic abrasive particles. Other processes to make other species of shaped ceramic abrasive particles include extruding the precursor ceramic abrasive particle through an orifice having a predetermined shape, printing the precursor ceramic abrasive particle though an opening in a printing screen having a predetermined shape, or embossing the precursor ceramic abrasive particle into a predetermined shape or pattern. In other embodiments, the shaped ceramic abrasive particles can be cut from a sheet into individual particles. Examples of suitable cutting methods include mechanical cutting, laser cutting, or water-jet cutting. Non-limiting embodiments of shaped ceramic abrasive particles include shaped abrasive particles, such as triangular plates, or elongated ceramic rods/filaments. Shaped ceramic abrasive particles are generally homogenous or substantially uniform and maintain their sintered shape without the use of a binder such as an organic or inorganic binder that bonds smaller abrasive particles into an agglomerated structure and excludes abrasive particles obtained by a crushing or comminution process that produces abrasive particles of random size and shape. In many embodiments, the shaped ceramic abrasive particles comprise a homogeneous structure of sintered alpha alumina or consist essentially of sintered alpha alumina.

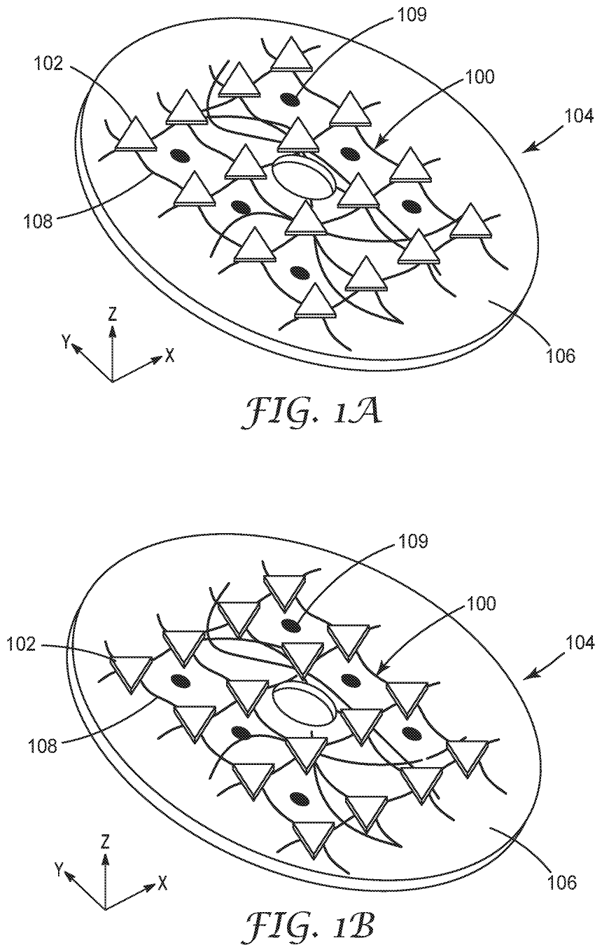

FIG. 1A is a perspective view of bonded abrasive article precursor 100. FIG. 1B is a perspective view of bonded abrasive article precursor 100 in which shaped abrasive particles 102 are rotated 90 degrees about a z-axis relative to those shown in FIG. 1A. Bonded abrasive article precursor 100 includes a plurality of shaped abrasive particles 102 adhered to substrate 104. Substrate 104 includes adhesive 106 and optional backing 108. Substrate 104 can further include optional perforations 109 extending through substrate 104. As shown, bonded abrasive article precursor 100 has a circular shape. However, bonded abrasive article precursor 100 can have a polygonal shape; alternatively, bonded abrasive article precursor can have a conical shape. If bonded abrasive article precursor 100 has a generally circular profile, a major diameter of bonded abrasive article precursor 100 can be in a range of from 2 mm to about 2000 mm, about 200 mm to about 1000 mm, less than, equal to, or greater than about 2 mm, 10, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 mm.

The predetermined pattern of shaped abrasive particles 102 can conform to any desired predetermined pattern. For example, shaped abrasive particles 102 can be arranged as a plurality of parallel lines, in a circle, in staggered rows, in a spiral, or the like. As shown in FIGS. 1A and 1B, shaped abrasive particles 102 are arranged in a plurality of rows on substrate 104.

Substrate 104 can be relatively thin. For example, substrate 104 can have a thickness in a range of from about 25.4 μm to about 2550 μm, about 76.2 μm to about 762 μm, less than, equal to, or greater than about 25.4 μm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, 2300, 2350, 2400, 2450, 2500, or about 2550 μm. As shown, substrate 104 is substantially planar and has a constant thickness. However, in further embodiments, substrate 104 can be curved or have a substantially non-planar profile. In this case, the thickness is a measure of the largest thickness value of substrate 104. In still further embodiments, it is possible for substrate 104 to have a substantially helical shape centered about the z-axis.

Individual shaped abrasive particles 102 are adhered to substrate 104 by adhesive 106. Adhesive 106 can be any suitable class of adhesive. For example, the adhesive can include a thermoplastic resin, a thermoset resin, a radiation curable resin, or any mixture thereof. Examples of suitable thermoplastic resins include an acrylic adhesive, a rubber adhesive, a silicone adhesive, a styrene block copolymer adhesive, a polyvinyl ether-based adhesive, or a mixture thereof. An example of a suitable acrylic adhesive is one that includes a poly(meth)acrylate. Examples of suitable poly(meth)acrylates include poly(benzyl (meth)acrylate), poly(butyl (meth)acrylate), poly(cyclohexyl (meth)acrylate), poly(dodecyl (meth)acrylate), poly(2-ethoxyethyl (meth)acrylate), poly(ethyl (meth)acrylate), poly(hexyl (meth)acrylate), poly(2-hydroxyethyl (meth)acrylate), poly(isobutyl (meth)acrylate), poly(isopropyl (meth)acrylate), poly(methyl (meth)acrylate), poly(octadecyl (meth)acrylate), poly(octyl (meth)acrylate), poly(phenyl (meth)acrylate), poly(propyl (meth)acrylate), poly(2-chloroethyl (meth)acrylate), or mixtures thereof. Examples of suitable rubber adhesives are those where the rubber adhesive includes a natural rubber, a synthetic rubber, or a mixture thereof.

In embodiments where the adhesive includes a thermoset resin, the thermoset resin can include a phenol-formaldehyde resin or an epoxy resin. The phenol-formaldehyde resin may include a novolac, resole, or a mixture thereof. The epoxy resin can include one or more epoxy resins chosen from a diglycidyl ether of bisphenol F, a low epoxy equivalent weight diglycidyl ether of bisphenol A, a liquid epoxy novolac, a liquid aliphatic epoxy, a liquid cycloaliphatic epoxy, a 1,4-cyclohexandimethanoldiglycidylether, 3,4-epoxycyclohexylmethyl-3,4-epoxycyclohexane carboxylate, tetraglycidylmethylenedianiline, N,N,N′,N′-tetraglycidyl-4,4′-methylenebisbenzenamine, a triglycidyl of para-aminophenol, N,N,N′,N′-tetraglycidyl-m-xylenediamine, an acrylated epoxy resin, and a mixture thereof. Other thermosetting resins may include, a urea-formaldehyde resin, an aminoplast resin, a melamine resin, a urethane resin, or mixtures thereof.

In embodiments in which the epoxy resin includes an acrylated epoxy resin, the epoxy resin can include a tetrahydrofurfuryl (THF) (meth)acrylate copolymer component, one or more epoxy resins (such as those disclosed herein), and one or more hydroxy-functional polyethers. According to various embodiments, the THF (meth)acrylate copolymer component can be in a range of from about 15 to about 50 parts by weight of adhesive 106, about 20 to about 40 parts by weight, less than, equal to, or greater than about 15, 20, 25, 30, 35, 40, 45, or 50 parts by weight. The one or more epoxy resins can be in a range of from about 25 to about 50 parts by weight of adhesive 106, about 20 to about 40 parts by weight, less than, equal to, or greater than about 15, 20, 25, 30, 35, 40, 45, or 50 parts by weight. According to various embodiments, the hydroxy-functional polyethers can be in a range of from about 5 to about 15 parts by weight of adhesive 106, about 7 to about 10 parts by weight, less than, equal to, or greater than about 5 parts by weight, 6, 7, 8, 9, 10, 11, 12, 13, 14, or about 15 parts by weight. According to various embodiments, in which the epoxy resin includes an acrylated epoxy resin, the acrylated epoxy resin can include one or more hydroxyl-containing film-forming polymers (e.g., a polyvinyl alcohol, a poly(ethylene vinyl alcohol) copolymer, or a phenoxy resin), which can range from about 10 to about 25 parts by weight of adhesive 106, about 15 to about 20 parts by weight, less than, equal to, or greater than about 10 parts by weight, 15, 20, or about 25 parts by weight. According to various embodiments in which the epoxy resin includes an acrylated epoxy resin, the acrylated epoxy resin can include one or more photoinitiators, which can range from about 0.1 to about 5 parts by weight of adhesive 106, about 1 to about 3 parts by weight, less than, equal to, or greater than about 0.1 parts by weight, 0.5, 1, 1.5, 2, 2.5, 3, 3.5, 4, 4.5, or about 5 parts by weight.

The THF (meth)acrylate copolymer component can include one or more THF (meth)acrylate monomers, one or more Ci-Cs (meth)acrylate ester monomers, and one or more optional cationically reactive functional (meth)acrylate monomers. The tetrahydrofurfuryl (meth)acrylate monomers can be in a range of from about 40 wt % to about 60 wt % of the THF (meth)acrylate copolymer component, about 50 wt % to about 55 wt %, less than, equal to, or greater than about 40 wt %, 41, 42, 43, 44, 45, 46, 47, 48, 49, 50, 51, 52, 53, 54, 55, 56, 57, 58, 59, or about 60 wt %. The one or more Ci-Cs (meth)acrylate ester monomers can be in a range of from about 40 wt % to about 60 wt % of the THF (meth)acrylate copolymer component, about 50 wt % to about 55 wt %, less than, equal to, or greater than about 40 wt %, 41, 42, 43, 44, 45, 46, 47, 48, 49, 50, 51, 52, 53, 54, 55, 56, 57, 58, 59, or about 60 wt %. The cationically reactive functional (meth)acrylate monomers can be in a range of from 0 wt % to about 10 wt % of the THF (meth)acrylate copolymer component, about 2 wt % to about 5 wt %, less than, equal to, or greater than about 0 wt %, 1, 2, 3, 4, 5, 6, 7, 8, 9, or about 10 wt %.

In further embodiments in which adhesive 106 is a thermoplastic resin, the thermoplastic resin can include a hydrogenated polybutadiene, a polytetramethylene ether glycol, a copolymer of isooctyl acrylate and acrylic acid, an aliphatic zwitterionic amphiphilic acrylic polymer. Aa phenolic resin, which may be thermoplastic or thermosetting may also be used. Bonded abrasive article precursor 100 can further include backing 108. As shown in FIGS. 1A and 1B, backing 108 has adhesive 106 disposed thereon, and adhesive 106 has shaped abrasive particles 102 embedded therein. Backing 108 can be a substantially porous material, which can allow a material to flow through the body of backing 108. Alternatively, backing 108 may be a substantially continuous structure. A reinforcing component can include any suitable material such as a polymeric film that can be perforated, a metal foil that can be perforated, a woven fabric, a knitted fabric, paper that can be perforated, a vulcanized fiber, a nonwoven, a foam, a perforated screen, a laminate that can be perforated, a fibrous web, or a combination thereof. In embodiments where backing 108 is a fibrous web, the fibrous web can include a plurality of fibers forming a non-woven web and having the adhesive disposed on the individual fibers, a spun-bound non-woven web, a needle-entangled non-woven web, a braided web, a knit web, a woven web, a blown microfiber, or a combination thereof. In some embodiments, where backing 108 includes a plurality of fibers, the fibrous web can include a yarn comprising a plurality of the fibers.

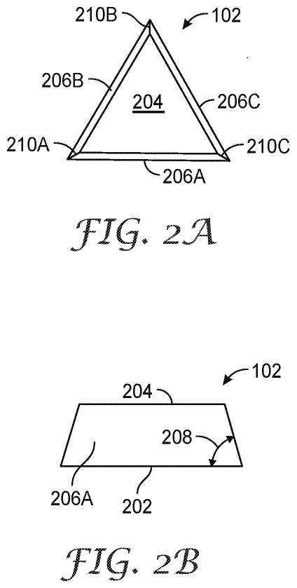

As shown in FIGS. 1A and 1B, shaped abrasive particles 102 are generally triangular shaped abrasive particles. Individual shaped abrasive particles 102 are shown in more detail in FIGS. 2A and 2B. As shown in FIGS. 2A and 2B, shaped abrasive particle 102 includes a truncated regular triangular pyramid bounded by a triangular base 202, a triangular top 204, and plurality of sloping sides 206A, 206B, 206C connecting triangular base 202 (shown as equilateral although scalene, obtuse, isosceles, and right triangles are possible) and triangular top 204. Slope angle 208 is the dihedral angle formed by the intersection of side 206A with triangular base 202. Similarly, slope angles 208B and 208C (both not shown) correspond to the dihedral angles formed by the respective intersections of sides 206B and 206C with triangular base 202. In the case of shaped abrasive particle 102, all of the slope angles have equal value. In some embodiments, side edges 210A, 210B, and 210C have an average radius of curvature in a range of from about 0.5 μm to about 80 μm, about 10 μm to about 60 μm, or less than, equal to, or greater than about 0.5 μm, 5, 10, 15, 20, 25, 30, 35, 40, 45, 50, 55, 60, 65, 70, 75, or about 80 μm.

In the embodiment shown in FIGS. 2A and 2B, sides 206A, 206B, and 206C have equal dimensions and form dihedral angles with the triangular base 202 of about 82 degrees (corresponding to a slope angle of 82 degrees). However, it will be recognized that other dihedral angles (including 90 degrees) may also be used. For example, the dihedral angle between the base and each of the sides may independently range from 45 to 90 degrees (for example, from 70 to 90 degrees, or from 75 to 85 degrees). Edges connecting sides 206, base 202, and top 204 can have any suitable length. For example, a length of the edges may be in a range of from about 0.5 μm to about 2000 μm, about 150 μm to about 200 μm, or less than, equal to, or greater than about 0.5 μm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 μm.

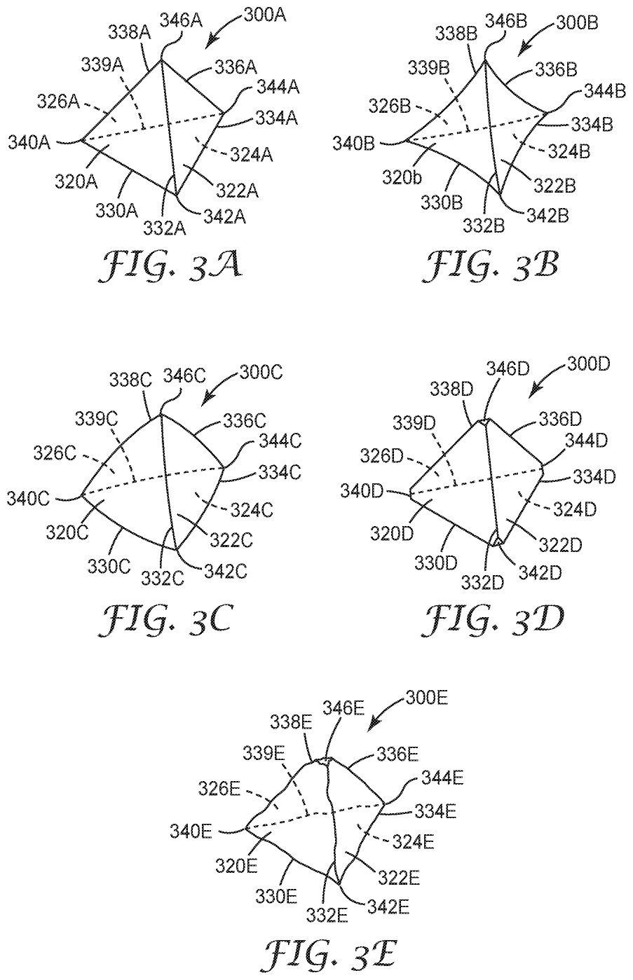

Although FIGS. 2A and 2B show triangular shaped abrasive particles 102, there are many other suitable examples of shaped abrasive particles that may be included in bonded abrasive article precursor 100. For example, bonded abrasive article precursor 100 can include tetrahedral shaped abrasive particles. FIGS. 3A-3E show various embodiments of tetrahedral shaped abrasive particles 300. As shown in FIGS. 3A-3E, shaped abrasive particles 300 are shaped as regular tetrahedrons. As shown in FIG. 3A, shaped abrasive particle 300A has four faces (320A, 322A, 324A, and 326A) joined by six edges (330A, 332A, 334A, 336A, 338A, and 339A) terminating at four vertices (340A, 342A, 344A, and 346A). Each of the faces contacts the other three of the faces at the edges. While a regular tetrahedron (e.g., having six equal edges and four faces) is depicted in FIG. 3A, it will be recognized that other shapes are also permissible. For example, tetrahedral abrasive particles 300 can be shaped as irregular tetrahedrons (e.g., having edges of differing lengths).

Referring now to FIG. 3B, shaped abrasive particle 300B has four faces (320B, 322B, 324B, and 326B) joined by six edges (330B, 332B, 334B, 338B, and 339B) terminating at four vertices (340B, 342B, 344B, and 346B). Each of the faces is concave and contacts the other three of the faces at respective common edges. While a particle with tetrahedral symmetry (e.g., four rotational axes of threefold symmetry and six reflective planes of symmetry) is depicted in FIG. 3B, it will be recognized that other shapes are also permissible. For example, shaped abrasive particles 300B can have one, two, or three concave faces with the remainder being planar.

Referring now to FIG. 3C, shaped abrasive particle 300C has four faces (320C, 322C, 324C, and 326C) joined by six edges (330C, 332C, 334C, 336C, 338C, and 339C) terminating at four vertices (340C, 342C, 344C, and 346C). Each of the faces is convex and contacts the other three of the faces at respective common edges. While a particle with tetrahedral symmetry is depicted in FIG. 3C, it will be recognized that other shapes are also permissible. For example, shaped abrasive particles 300C can have one, two, or three convex faces with the remainder being planar or concave.

Referring now to FIG. 3D, shaped abrasive particle 300D has four faces (320D, 322D, 324D, and 326D) joined by six edges (330D, 332D, 334D, 336D, 338D, and 339D) terminating at four vertices (340D, 342D, 344D, and 346D). While a particle with tetrahedral symmetry is depicted in FIG. 3D, it will be recognized that other shapes are also permissible. For example, shaped abrasive particles 300D can have one, two, or three convex faces with the remainder being planar.

Deviations from the depictions in FIGS. 3A-3D can be present. An example of such a shaped abrasive particle 300 is depicted in FIG. 3E, showing shaped abrasive particle 300E, which has four faces (320E, 322E, 324E, and 326E) joined by six edges (330E, 332E, 334E, 338E, and 339E) terminating at four vertices (340E, 342E, 344E, and 346E). Each of the faces contacts the other three of the faces at respective common edges. Each of the faces, edges, and vertices has an irregular shape.

In any of shaped abrasive particles 300A-300E, the edges can have the same length or different lengths. The length of any of the edges can be any suitable length. As an example, the length of the edges can be in a range of from about 0.5 μm to about 2000 μm, about 150 μm to about 200 μm, or less than, equal to, or greater than about 0.5 μm, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, or about 2000 μm. Shaped abrasive particles 300A-300E can be the same size or different sizes.

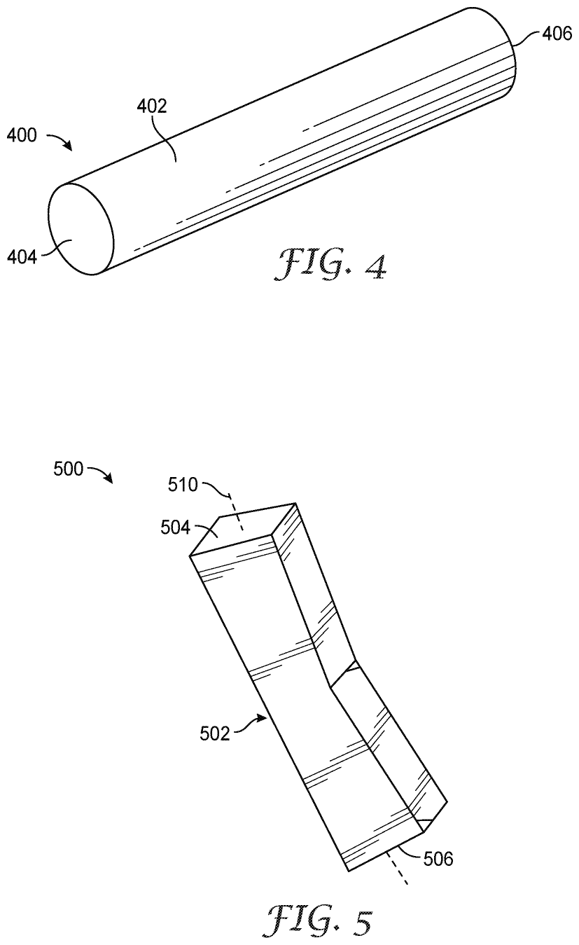

In other embodiments, shaped abrasive particles may be shaped as a cylinder as shown in FIG. 4. FIG. 4 is a perspective view showing shaped abrasive particle 400. Shaped abrasive particle 400 includes a cylindrically shaped body 402 extending between circular first and second ends 404 and 406.

In other embodiments, shaped abrasive particles may be shaped to have a bowtie shape as shown in FIG. 5. FIG. 5 is a perspective view of abrasive particle 500. Abrasive particle 500 includes elongated body 502, which is defined between opposed first end 504 and second end 506, having axis 510 extending through each end. An aspect ratio of a length to a width of abrasive particle 500 can range from about 3:1 to about 6:1, or from about 4:1 to about 5:1.

Axis 510 extends through the middle of elongated body 502, first end 504, and second end 506. As illustrated, the axis 510 is a non-orthogonal axis, but in other embodiments the axis can be a straight axis. As illustrated, each of first end 504 and second end 506 define a substantially planar surface. Both first end 504 and second end 506 are oriented at an angle relative to axis 510 that is less than 90 degrees, and each end is non-parallel with respect to each other. In other embodiments, only one of first and second ends 504 and 506 are oriented at an angle relative to axis 510 that is less than 90 degrees. First end 504 and second end 506 have respective first and second cross-sectional areas. As illustrated, the first and second cross-sectional areas are substantially the same. But in other embodiments, the first and second cross-sectional areas can be different. Elongated body 502 tapers inward from first end 504 and second end 506 to a mid-point having a cross-sectional area that is smaller than that of first or second ends 504 and 506.

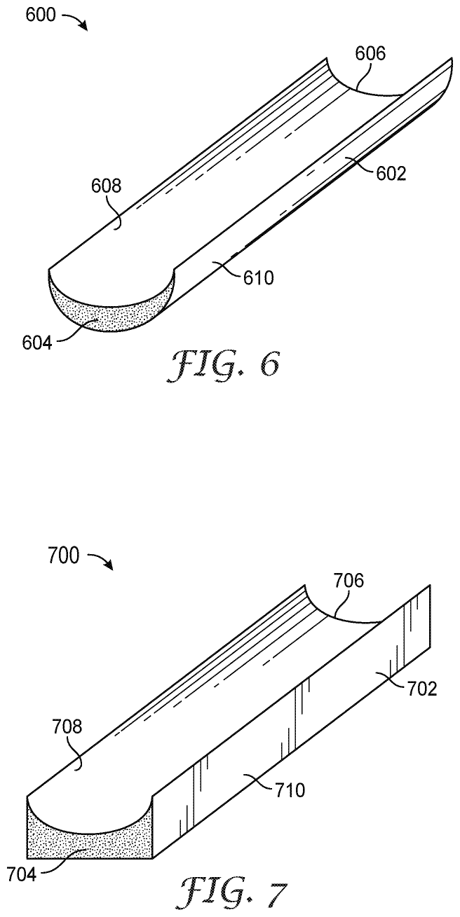

In other embodiments, as shown in FIG. 6, shaped abrasive particle 600 has an elongate shaped ceramic body 602 having opposed first and second ends 604, 606 joined to each other by longitudinal sidewalls 608, 610. Longitudinal sidewall 608 is concave along its length. First and second ends 604 and 606 are fractured surfaces.

In other embodiments, as shown in FIG. 7, shaped abrasive particle 700 has an elongate shaped ceramic body 702 having opposed first and second ends 704, 706 joined to each other by longitudinal sidewalls 708 and 710. Longitudinal sidewall 708 is concave along its length. First and second ends 704, 706 are fractured surfaces.

Shaped abrasive particles 600 and 700 have an aspect ratio of at least 2. In some embodiments, shaped abrasive particles 600 and 700 have an aspect ratio of at least 4, at least 6, or even at least 10.

Any of shaped abrasive particles 102, 300, 400, 500, 600, or 700 can include any number of shape features. The shape features can help to improve the cutting performance of any of shaped abrasive particles 102, 300, 400, 500, 600, or 700. Examples of suitable shape features include an opening, a concave surface, a convex surface, a groove, a ridge, a fractured surface, a low roundness factor, or a perimeter comprising one or more corner points having a sharp tip. Individual shaped abrasive particles can include any one or more of these features.

Shaped abrasive particles 102, 300, 400, 500, 600, or 700 or any crushed abrasive particles further described herein can include any suitable material or mixture of materials. For example, shaped abrasive particles 102, 300, 400, 500, 600, or 700 can include a material chosen from an alpha-alumina, a fused aluminum oxide, a heat-treated aluminum oxide, a ceramic aluminum oxide, a sintered aluminum oxide, a silicon carbide, a titanium diboride, a boron carbide, a tungsten carbide, a titanium carbide, a diamond, a cubic boron nitride, a garnet, a fused alumina-zirconia, a sol-gel derived abrasive particle, a cerium oxide, a zirconium oxide, a titanium oxide, and combinations thereof. In some embodiments, shaped abrasive particles 102, 300, 400, 500, 600, or 700 and crushed abrasive particles can include the same materials. In further embodiments, shaped abrasive particles 102, 300, 400, 500, 600, or 700 and crushed abrasive particles can include different materials.

In addition to the materials already described, at least one magnetic material may be included within or coated to shaped abrasive particle 102, 300, 400, 500, 600, or 700. Examples of magnetic materials include iron; cobalt; nickel; various alloys of nickel and iron marketed as Permalloy in various grades; various alloys of iron, nickel and cobalt marketed as Fernico, Kovar, FerNiCo I, or FerNiCo II; various alloys of iron, aluminum, nickel, cobalt, and sometimes also copper and/or titanium marketed as Alnico in various grades; alloys of iron, silicon, and aluminum (about 85:9:6 by weight) marketed as Sendust alloy; Heusler alloys (e.g., Cu₂MnSn); manganese bismuthide (also known as Bismanol); rare earth magnetizable materials such as gadolinium, dysprosium, holmium, europium oxide, alloys of neodymium, iron and boron (e.g., Nd₂Fe₁₄B), and alloys of samarium and cobalt (e.g., SmCo₅); MnSb; MnOFe₂O₃; Y₃Fe₅O₁₂; CrO₂; MnAs; ferrites such as ferrite, magnetite, zinc ferrite; nickel ferrite; cobalt ferrite, magnesium ferrite, barium ferrite, and strontium ferrite; yttrium iron garnet; and combinations of the foregoing. In some embodiments, the magnetizable material is an alloy containing 8 to 12 weight percent aluminum, 15 to 26 wt % nickel, 5 to 24 wt % cobalt, up to 6 wt % copper, up to 1% titanium, wherein the balance of material to add up to 100 wt % is iron. In some other embodiments, a magnetizable coating can be deposited on an abrasive particle 102 using a vapor deposition technique such as, for example, physical vapor deposition (PVD) including magnetron sputtering.

Including these magnetizable materials can allow shaped abrasive particle 102, 300, 400, 500, 600, or 700 to be responsive to a magnetic field. Any of shaped abrasive particles 102, 300, 400, 500, 600, or 700 can include the same material or include different materials.

Furthermore, some shaped abrasive particles 102, 300, 400, 500, 600, or 700 can include a polymeric material and can be characterized as soft abrasive particles. The soft shaped abrasive particles described herein can independently include any suitable material or combination of materials. For example, the soft shaped abrasive particles can include a reaction product of a polymerizable mixture including one or more polymerizable resins, the one or more polymerizable resins such as a hydrocarbyl polymerizable resin. Examples of such resins include those chosen from a phenolic resin, a urea formaldehyde resin, a urethane resin, a melamine resin, an epoxy resin, a bismaleimide resin, a vinyl ether resin, an aminoplast resin (which may include pendant alpha, beta unsaturated carbonyl groups), an acrylate resin, an acrylated isocyanurate resin, an isocyanurate resin, an acrylated urethane resin, an acrylated epoxy resin, an alkyl resin, a polyester resin, a drying oil, or mixtures thereof. The polymerizable mixture can include additional components such as a plasticizer, an acid catalyst, a cross-linker, a surfactant, a mild-abrasive, a pigment, a catalyst and an antibacterial agent.

Where multiple components are present in the polymerizable mixture, those components can account for any suitable weight percentage of the mixture. For example, the polymerizable resin or resins may be in a range of from about 35 wt % to about 99.9 wt % of the polymerizable mixture, about 40 wt % to about 95 wt %, or less than, equal to, or greater than about 35 wt %, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or about 99.9 wt %.

If present, the cross-linker may be in a range of from about 2 wt % to about 60 wt % of the polymerizable mixture, from about 5 wt % to about 10 wt %, or less than, equal to, or greater than about 2 wt %, 3, 4, 5, 6, 7, 8, 9, 10, 11, 12, 13, 14, or about 15 wt %. Examples of suitable cross-linkers include a cross-linker available under the trade designation CYMEL 303 LF, of Allnex USA Inc., Alpharetta, Ga., USA; or a cross-linker available under the trade designation CYMEL 385, of Allnex USA Inc., Alpharetta, Ga., USA.

If present, the mild-abrasive may be in a range of from about 5 wt % to about 65 wt % of the polymerizable mixture, about 10 wt % to about 20 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or about 65 wt %. Examples of suitable mild-abrasives include a mild-abrasive available under the trade designation MINSTRON 353 TALC, of Imerys Talc America, Inc., Three Forks, Mont., USA; a mild-abrasive available under the trade designation USG TERRA ALBA NO. 1 CALCIUM SULFATE, of USG Corporation, Chicago, Ill., USA; Recycled Glass (40-70 Grit) available from ESCA Industries, Ltd., Hatfield, Pa., USA, silica, calcite, nepheline, syenite, calcium carbonate, or mixtures thereof.

If present, the plasticizer may be in a range of from about 5 wt % to about 40 wt % of the polymerizable mixture, about 10 wt % to about 15 wt %, or less than, equal to, or greater than about 5 wt %, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or about 40 wt %. Examples of suitable plasticizers include acrylic resins or styrene butadiene resins. Examples of acrylic resins include an acrylic resin available under the trade designation RHOPLEX GL-618, of DOW Chemical Company, Midland, Mich., USA; an acrylic resin available under the trade designation HYCAR 2679, of the Lubrizol Corporation, Wickliffe, Ohio, USA; an acrylic resin available under the trade designation HYCAR 26796, of the Lubrizol Corporation, Wickliffe, Ohio, USA; a polyether polyol available under the trade designation ARCOL LG-650, of DOW Chemical Company, Midland, Mich., USA; or an acrylic resin available under the trade designation HYCAR 26315, of the Lubrizol Corporation, Wickliffe, Ohio, USA. An example of a styrene butadiene resin includes a resin available under the trade designation ROVENE 5900, of Mallard Creek Polymers, Inc., Charlotte, N.C., USA.

If present, the acid catalyst may be in a range of from 1 wt % to about 20 wt % of the polymerizable mixture, about 5 wt % to about 10 wt %, or less than, equal to, or greater than about 1 wt %, 2, 3, 4, 5, 6, 7, 8, 9, 10, 11, 12, 13, 14, 15, 16, 17, 18, 19, or about 20 wt %. Examples of suitable acid catalysts include a solution of aluminum chloride or a solution of ammonium chloride.

If present, the surfactant can be in a range of from about 0.001 wt % to about 15 wt % of the polymerizable mixture, about 5 wt % to about 10 wt %, less than, equal to, or greater than about 0.001 wt %, 0.01, 0.5, 1, 2, 3, 4, 5, 6, 7, 8, 9, 10, 11, 12, 13, 14, or about 15 wt %. Examples of suitable surfactants include a surfactant available under the trade designation GEMTEX SC-85-P, of Innospec Performance Chemicals, Salisbury, N.C., USA; a surfactant available under the trade designation DYNOL 604, of Air Products and Chemicals, Inc., Allentown, Pa., USA; a surfactant available under the trade designation ACRYSOL RM-8W, of DOW Chemical Company, Midland, Mich., USA; or a surfactant available under the trade designation XIAMETER AFE 1520, of DOW Chemical Company, Midland, Mich., USA.

If present, the antimicrobial agent may be in a range of from 0.5 wt % to about 20 wt % of the polymerizable mixture, about 10 wt % to about 15 wt %, or less than, equal to, or greater than about 0.5 wt %, 1, 2, 3, 4, 5, 6, 7, 8, 9, 10, 11, 12, 13, 14, 15, 16, 17, 18, 19, or about 20 wt %. An example of a suitable antimicrobial agent includes zinc pyrithione.

If present, the pigment may be in a range of from about 0.1 wt % to about 10 wt % of the polymerizable mixture, about 3 wt % to about 5 wt %, less than, equal to, or greater than about 0.1 wt %, 0.2, 0.4, 0.6, 0.8, 1, 1.5, 2, 2.5, 3, 3.5, 4, 4.5, 5, 5.5, 6, 6.5, 7, 7.5, 8, 8.5, 9, 9.5, or about 10 wt %. Examples of suitable pigments include a pigment dispersion available under the trade designation SUNSPERSE BLUE 15, of Sun Chemical Corporation, Parsippany, N.J., USA; a pigment dispersion available under the trade designation SUNSPERSE VIOLET 23, of Sun Chemical Corporation, Parsippany, N.J., USA; a pigment dispersion available under the trade designation SUN BLACK, of Sun Chemical Corporation, Parsippany, N.J., USA; or a pigment dispersion available under the trade designation BLUE PIGMENT B2G, of Clariant Ltd., Charlotte, N.C., USA. The mixture of components can be polymerized by curing.

Shaped abrasive particle 102, 300, 400, 500, 600, or 700 can be formed in many suitable manner; for example, the shaped abrasive particle 102, 300, 400, 500, 600, or 700 can be made according to a multi-operation process. The process can be carried out using any material or precursor dispersion material. Briefly, for embodiments where shaped abrasive particles 102, 300, 400, 500, 600, or 700 are monolithic ceramic particles, the process can include the operations of making either a seeded or non-seeded precursor dispersion that can be converted into a corresponding ceramic (e.g., a boehmite sol-gel that can be converted to alpha alumina); filling one or more mold cavities having the desired outer shape of shaped abrasive particle 102, 300, 400, 500, 600, or 700 with a precursor dispersion; drying the precursor dispersion to form precursor shaped abrasive particle; removing the precursor shaped abrasive particle 102, 300, 400, 500, 600, or 700 from the mold cavities; calcining the precursor shaped abrasive particle 102, 300, 400, 500, 600, or 700 to form calcined, precursor shaped abrasive particle 102, 300, 400, 500, 600, or 700; and then sintering the calcined, precursor shaped abrasive particle 102, 300, 400, 500, 600, or 700 to form shaped abrasive particle 102, 300, 400, 500, 600, or 700. The process will now be described in greater detail in the context of alpha-alumina-containing shaped abrasive particle 102, 300, 400, 500, 600, or 700. In other embodiments, the mold cavities may be filled with a melamine to form melamine shaped abrasive particles.

The process can include the operation of providing either a seeded or non-seeded dispersion of a precursor that can be converted into ceramic. In examples where the precursor is seeded, the precursor can be seeded with an oxide of an iron (e.g., FeO). The precursor dispersion can include a liquid that is a volatile component. In one example, the volatile component is water. The dispersion can include a sufficient amount of liquid for the viscosity of the dispersion to be sufficiently low to allow filling mold cavities and replicating the mold surfaces, but not so much liquid as to cause subsequent removal of the liquid from the mold cavity to be prohibitively expensive. In one example, the precursor dispersion includes from 2 percent to 90 percent by weight of the particles that can be converted into ceramic, such as particles of aluminum oxide monohydrate (boehmite), and at least 10 percent by weight, or from 50 percent to 70 percent, or 50 percent to 60 percent, by weight, of the volatile component such as water. Conversely, the precursor dispersion in some embodiments contains from 30 percent to 50 percent, or 40 percent to 50 percent solids by weight.

Examples of suitable precursor dispersions include zirconium oxide sols, vanadium oxide sols, cerium oxide sols, aluminum oxide sols, and combinations thereof. Suitable aluminum oxide dispersions include, for example, boehmite dispersions and other aluminum oxide hydrates dispersions. Boehmite can be prepared by known techniques or can be obtained commercially. Examples of commercially available boehmite include products having the trade designations “DISPERAL” and “DISPAL”, both available from Sasol North America, Inc., or “HIQ-40” available from BASF Corporation. These aluminum oxide monohydrates are relatively pure; that is, they include relatively little, if any, hydrate phases other than monohydrates, and have a high surface area.

The physical properties of the resulting shaped abrasive particle 102, 300, 400, 500, 600, or 700 can generally depend upon the type of material used in the precursor dispersion. As used herein, a “gel” is a three-dimensional network of solids dispersed in a liquid.

The precursor dispersion can contain a modifying additive or precursor of a modifying additive. The modifying additive can function to enhance some desirable property of the abrasive particles or increase the effectiveness of the subsequent sintering step. Modifying additives or precursors of modifying additives can be in the form of soluble salts, such as water-soluble salts. They can include a metal-containing compound and can be a precursor of an oxide of magnesium, zinc, iron, silicon, cobalt, nickel, zirconium, hafnium, chromium, yttrium, praseodymium, samarium, ytterbium, neodymium, lanthanum, gadolinium, cerium, dysprosium, erbium, titanium, and mixtures thereof. The particular concentrations of these additives that can be present in the precursor dispersion can be varied.

The introduction of a modifying additive or precursor of a modifying additive can cause the precursor dispersion to gel. The precursor dispersion can also be induced to gel by application of heat over a period of time to reduce the liquid content in the dispersion through evaporation. The precursor dispersion can also contain a nucleating agent. Nucleating agents suitable for this disclosure can include fine particles of alpha alumina, alpha ferric oxide or its precursor, titanium oxides and titanates, chrome oxides, or any other material that will nucleate the transformation. The amount of nucleating agent, if used, should be sufficient to effect the transformation of alpha alumina.

A peptizing agent can be added to the precursor dispersion to produce a more stable hydrosol or colloidal precursor dispersion. Suitable peptizing agents are monoprotic acids or acid compounds such as acetic acid, hydrochloric acid, formic acid, and nitric acid. Multiprotic acids can also be used, but they can rapidly gel the precursor dispersion, making it difficult to handle or to introduce additional components. Some commercial sources of boehmite contain an acid titer (such as absorbed formic or nitric acid) that will assist in forming a stable precursor dispersion.

The precursor dispersion can be formed by any suitable means; for example, in the case of a sol-gel alumina precursor, it can be formed by simply mixing aluminum oxide monohydrate with water containing a peptizing agent or by forming an aluminum oxide monohydrate slurry to which the peptizing agent is added.

Defoamers or other suitable chemicals can be added to reduce the tendency to form bubbles or entrain air while mixing. Additional chemicals such as wetting agents, alcohols, or coupling agents can be added if desired.

A further operation can include providing a mold having at least one mold cavity, or a plurality of cavities formed in at least one major surface of the mold. In some examples, the mold is formed as a production tool, which can be, for example, a belt, a sheet, a continuous web, a coating roll such as a rotogravure roll, a sleeve mounted on a coating roll, or a die. In one example, the production tool can include polymeric material. Examples of suitable polymeric materials include thermoplastics such as polyesters, polycarbonates, poly(ether sulfone), poly(methyl (meth)acrylate), polyurethanes, polyvinylchloride, polyolefin, polystyrene, polypropylene, polyethylene or combinations thereof, or thermosetting materials. In one example, the entire tool is made from a polymeric or thermoplastic material. In another example, the surfaces of the tool in contact with the precursor dispersion while the precursor dispersion is drying, such as the surfaces of the plurality of cavities, include polymeric or thermoplastic materials, and other portions of the tool can be made from other materials. A suitable polymeric coating can be applied to a metal tool to change its surface tension properties, by way of example.

A polymeric or thermoplastic production tool can be replicated off a metal master tool. The master tool can have the inverse pattern of that desired for the production tool. The master tool can be made in the same manner as the production tool. In one example, the master tool is made out of metal (e.g., nickel) and is diamond-turned. In one example, the master tool is at least partially formed using stereolithography. The polymeric sheet material can be heated along with the master tool such that the polymeric material is embossed with the master tool pattern by pressing the two together. A polymeric or thermoplastic material can also be extruded or cast onto the master tool and then pressed. The thermoplastic material is cooled to solidify and produce the production tool. If a thermoplastic production tool is utilized, then care should be taken not to generate excessive heat that can distort the thermoplastic production tool, limiting its life.

Access to cavities can be from an opening in the top surface or bottom surface of the mold. In some examples, the cavities can extend for the entire thickness of the mold. Alternatively, the cavities can extend only for a portion of the thickness of the mold. In one example, the top surface is substantially parallel to the bottom surface of the mold with the cavities having a substantially uniform depth. At least one side of the mold, the side in which the cavities are formed, can remain exposed to the surrounding atmosphere during the step in which the volatile component is removed.

The cavities have a specified three-dimensional shape to make shaped abrasive particle 102. The depth dimension is equal to the perpendicular distance from the top surface to the lowermost point on the bottom surface. The depth of a given cavity can be uniform or can vary along its length and/or width. The cavities of a given mold can be of the same shape or of different shapes.

A further operation involves filling the cavities in the mold with the precursor dispersion (e.g., by a conventional technique). In some examples, a knife roll coater or vacuum slot die coater can be used. A mold release agent can be used to aid in removing the particles from the mold if desired. Examples of mold release agents include oils such as peanut oil or mineral oil, fish oil, silicones, polytetrafluoroethylene, zinc stearate, and graphite. In general, a mold release agent such as peanut oil, in a liquid, such as water or alcohol, is applied to the surfaces of the production tool in contact with the precursor dispersion such that from about 0.1 mg/in² (0.6 mg/cm²) to about 3.0 mg/in² (20 mg/cm²), or from about 0.1 mg/in² (0.6 mg/cm²) to about 5.0 mg/in² (30 mg/cm²), of the mold release agent is present per unit area of the mold when a mold release is desired. In some embodiments, the top surface of the mold is coated with the precursor dispersion. The precursor dispersion can be pumped onto the top surface.

In a further operation, a scraper or leveler bar can be used to force the precursor dispersion fully into the cavity of the mold. The remaining portion of the precursor dispersion that does not enter the cavity can be removed from the top surface of the mold and recycled. In some examples, a small portion of the precursor dispersion can remain on the top surface, and in other examples the top surface is substantially free of the dispersion. The pressure applied by the scraper or leveler bar can be less than 100 psi (0.6 MPa), or less than 50 psi (0.3 MPa), or even less than 10 psi (60 kPa). In some examples, no exposed surface of the precursor dispersion extends substantially beyond the top surface.

In those examples where it is desired to have the exposed surfaces of the cavities result in planar faces of the shaped abrasive particles, it can be desirable to overfill the cavities (e.g., using a micronozzle array) and slowly dry the precursor dispersion.

A further operation involves removing the volatile component to dry the dispersion. The volatile component can be removed by fast evaporation rates. In some examples, removal of the volatile component by evaporation occurs at temperatures above the boiling point of the volatile component. An upper limit to the drying temperature often depends on the material the mold is made from. For polypropylene tool, the temperature should be less than the melting point of the plastic. In one example, for a water dispersion of from about 40 to 50 percent solids and a polypropylene mold, the drying temperatures can be from about 90° C. to about 165° C., or from about 105° C. to about 150° C., or from about 105° C. to about 120° C. Higher temperatures can lead to improved production speeds but can also lead to degradation of the polypropylene tool, limiting its useful life as a mold.

During drying, the precursor dispersion shrinks, often causing retraction from the cavity walls. For example, if the cavities have planar walls, then the resulting shaped abrasive particle 102 can tend to have at least three concave major sides. It is presently discovered that by making the cavity walls concave (whereby the cavity volume is increased) it is possible to obtain shaped abrasive particle 102, 300, 400, 500, 600, or 700 that have at least three substantially planar major sides. The degree of concavity generally depends on the solids content of the precursor dispersion.

A further operation involves removing resultant precursor shaped abrasive particle 102, 300, 400, 500, 600, or 700 from the mold cavities. The precursor shaped abrasive particle 102, 300, 400, 500, 600, or 700 can be removed from the cavities by using the following processes alone or in combination on the mold: gravity, vibration, ultrasonic vibration, vacuum, or pressurized air to remove the particles from the mold cavities.

The precursor shaped abrasive particle 102, 300, 400, 500, 600, or 700 can be further dried outside of the mold. If the precursor dispersion is dried to the desired level in the mold, this additional drying step is not necessary. However, in some instances it can be economical to employ this additional drying step to minimize the time that the precursor dispersion resides in the mold. The precursor shaped abrasive particle 102, 300, 400, 500, 600, or 700 will be dried from 10 to 480 minutes, or from 120 to 400 minutes, at a temperature from 50° C. to 160° C., or 120° C. to 150° C.

A further operation involves calcining the precursor shaped abrasive particle 102, 300, 400, 500, 600, or 700. During calcining, essentially all the volatile material is removed, and the various components that were present in the precursor dispersion are transformed into metal oxides. The precursor shaped abrasive particle 102, 300, 400, 500, 600, or 700 is generally heated to a temperature from 400° C. to 800° C. and maintained within this temperature range until the free water and over 90 percent by weight of any bound volatile material are removed. In an optional step, it can be desirable to introduce the modifying additive by an impregnation process. A water-soluble salt can be introduced by impregnation into the pores of the calcined, precursor shaped abrasive particle 102, 300, 400, 500, 600, or 700. Then the precursor shaped abrasive particle 102, 300, 400, 500, 600, or 700 are pre-fired again.

A further operation can involve sintering the calcined, precursor shaped abrasive particle 102, 300, 400, 500, 600, or 700 to form particles 102, 300, 400, 500, 600, or 700. In some examples where the precursor includes rare earth metals, however, sintering may not be necessary. Prior to sintering, the calcined, precursor shaped abrasive particle 102, 300, 400, 500, 600, or 700 are not completely densified and thus lack the desired hardness to be used as shaped abrasive particle 102, 300, 400, 500, 600, or 700. Sintering takes place by heating the calcined, precursor shaped abrasive particle 102, 300, 400, 500, 600, or 700 to a temperature of from 1000° C. to 1650° C. The length of time for which the calcined, precursor shaped abrasive particle 102, 300, 400, 500, 600, or 700 can be exposed to the sintering temperature to achieve this level of conversion depends upon various factors, but from five seconds to 48 hours is possible.

In another embodiment, the duration of the sintering step ranges from one minute to 90 minutes. After sintering, shaped abrasive particle 102, 300, 400, 500, 600, or 700 can have a Vickers hardness of 10 GPa (gigaPascals), 16 GPa, 18 GPa, 20 GPa, or greater.

Additional operations can be used to modify the described process, such as, for example, rapidly heating the material from the calcining temperature to the sintering temperature, and centrifuging the precursor dispersion to remove sludge and/or waste. Moreover, the process can be modified by combining two or more of the process steps if desired.

As shown in FIGS. 1A and 1B, each of the plurality of shaped abrasive particles 102 can have a specified z-direction rotational orientation about a z-axis passing through individual shaped abrasive particles 102 and through backing 108 and adhesive 106 at a 90 degree angle to backing 108. Shaped abrasive particles 102 are orientated with a surface feature, such as a substantially planar surface of particle 102, rotated into a specified angular position about the z-axis. The specified z-direction rotational orientation occurs more frequently than would occur by a random z-directional rotational orientation of the surface feature due to electrostatic coating or drop coating of shaped abrasive particles 102, 300, 400, 500, 600, or 700 when forming bonded abrasive article precursor 100. As such, by controlling the z-direction rotational orientation of a significantly large number of shaped abrasive particles 102, the cut rate, finish, or both of a resulting bonded abrasive article to which bonded abrasive article precursor 100 is applied can be varied from those manufactured using an electrostatic coating method. In various embodiments, at least 50, 51, 55, 60, 65, 70, 75, 80, 85, 90, 95, or 99 percent of shaped abrasive particles 102 can have a specified z-direction rotational orientation which does not occur randomly and which can be substantially the same for all of the aligned particles. In other embodiments, about 50 percent of shaped abrasive particles 102 can be aligned in a first direction and about 50 percent of shaped abrasive particles 102 can be aligned in a second direction. In one embodiment, the first direction is substantially orthogonal to the second direction.

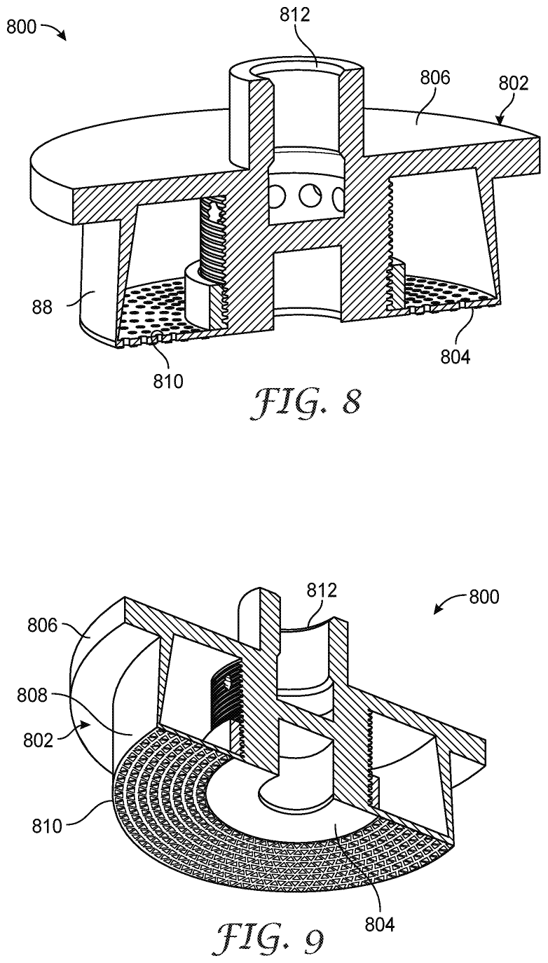

Bonded abrasive article precursor 100 can be formed to include the predetermined pattern of any one of shaped abrasive particles 100, 300, 400, 500, 600, or 700 by using apparatus 800, which is shown in FIGS. 8 and 9 by a sectional perspective view. FIGS. 8 and 9 are discussed concurrently. As shown, apparatus 800 includes housing 802. Housing 802 is formed from housing first major surface 804 and opposed housing second major surface 806. Housing first major surface 804 and housing second major surface 806 are connected by housing peripheral surface 808.

Apparatus first major surface 804 has a substantially planar profile and includes a plurality of holes 810 extending therethrough. Each hole 810 is adapted to receive an abrasive particle. At least some of holes 810 are further arranged on apparatus first major surface 804 in a pattern. The pattern can correspond to, for example, the predetermined pattern of the abrasive particles of bonded abrasive article precursor 100. In some examples, holes 810 can be randomly arranged. In still other examples, at least some of holes 810 can be arranged in a pattern, whereas other holes are randomly arranged.

The type of abrasive particle that hole 810 receives is a function of the size (e.g., width) and shape of each hole 810. Each hole 810 can receive particles that have a width smaller than the width of hole 810. This provides a first screening feature to help ensure that only desired abrasive particles are received by holes 810. A second screening feature is the shape of hole 810.

Holes 810 can have any suitable polygonal shape. For example, the polygonal shape can be substantially triangular, circular, rectangular, pentagonal, substantially hexagonal, and so forth. These shapes can be adapted to receive specific shaped abrasive particles. For example, if hole 810 is triangularly shaped, it may be best suited to receive a triangularly shaped abrasive particle. Due to the triangular shape, a square shaped abrasive particle will not fit in the hole (provided that the particle has a larger width than the hole). Thus, the shape of hole 810 in combination with the width can control the type of abrasive particle that is received.

In some examples, each of holes 810 can be in the shape of an equilateral triangular hole. A length of each side can range from about 0.5 mm to about 3 mm, or about 1 mm to about 1.5 mm, or less than about, equal to about, or greater than about 1 mm, 1.5 mm, 2 mm, or about 2.5 mm. An angle of a sidewall of each hole 810 may range from about 80 degrees to about 105 degrees relative to the bottom of each hole, or about 95 degrees to about 100 degrees, or less than about, equal to about, or greater than about 85 degrees, 90, 95, or 100 degrees. The depth of each hole may range from about 0.10 mm to about 0.50 mm, or about 0.20 mm to about 0.30 mm or less than about, equal to about, or greater than about 0.15 mm, 0.20, 0.25, 0.30, 0.35, 0.40, or 0.45 mm.

In addition to having regular shaped holes 810, apparatus 800 can have an irregular shape. That is, the shape of holes 810 can be designed to substantially match the shape of crushed abrasive particles. While great variety in the dimensions of holes 810 is possible, each hole can also be designed to have substantially the same size. This configuration may be desirable for applications in which each abrasive particle has the same size.

Holes 810 can be further shaped to have a smaller width on one end of hole 810 than on the other end. That is, the width of hole 810 at apparatus first major surface 804 can be wider than that of the internal end of hole 810. For example, the width of hole 810 at the first end can range from about 1.1 to about 4 times larger than the width of the hole at the second end, or about 2 to about 3 times larger, or less than about, equal to, or greater than about 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, or 4.9 times larger than the width of hole 810 at the second end. This way the abrasive particle will not pass completely through hole 804 and into housing 802. The interior of the holes 810 can also be sloped. This can allow for a specific orientation of shaped abrasive particles within hole 810. For example, some abrasive particles may have sloped sidewalls. The interior of holes 810 may in turn be sloped to match the sidewalls of the abrasive particles.

In some examples of apparatus 800, apparatus first major surface 804 can be releasably secured to housing 802. This can allow the apparatus to have interchangeable apparatus first surfaces. Each apparatus first surface can have differently sized holes or patterns of holes 810. Thus, apparatus 800 can be very versatile in terms of the types of abrasive particles that it may receive as well as the patterns it can create.

Apparatus 800 can releasably secure the abrasive particles in any number of sufficient ways. For example, as shown, housing 802 includes inlet 812 located on opposed housing second major surface 806. Inlet 812 can be adapted to be connected to a vacuum generation system. In operation, a low pressure (e.g., vacuum-like) environment can be created within housing 802. Thus, any abrasive particles disposed within the holes 810 are retained therein by suction. To release the abrasive particles, the vacuum generation system is turned off, thus resulting in a loss of suction. Alternatively, a magnet can be disposed within housing 802 that can be selectively engaged or disengaged. If the abrasive particles have metal in or on them, respectively, then they may be attracted to the magnet and drawn to the holes.

Bonded abrasive article precursor 100 can be made according to any suitable method. One method includes retaining a first plurality of abrasive particles 102, 300, 400, 500, 600, or 700 within a first portion of the plurality of holes 810 of apparatus 800 described herein. The first portion of the plurality of holes 810 can range from about 5% to about 100% of the total amount of holes 810 of apparatus 800, or from about 30% to about 60%, or less than about, equal to about, or greater than about 10%, 15, 20, 25, 30, 35, 40, 45, 50, 55, 60, 65, 70, 75, 80, 85, 90, or 95%. In embodiments where the first portion of the plurality of holes 810 is less than 100%, a second plurality of abrasive particles can be retained within a second portion of the plurality of holes 810 of apparatus 800. The second portion of the plurality of holes 810 can range from about 5% to about 99% of the total amount of holes of the apparatus, or from about 30% to about 60%, or less than about, equal to about, or greater than about 10%, 15, 20, 25, 30, 35, 40, 45, 50, 55, 60, 65, 70, 75, 80, 85, 90, or 95%. Abrasive particles 102, 300, 400, 500, 600, or 700 can be contacted with apparatus first major surface 804 by pouring the particles over the apparatus 800 or by immersing the apparatus 800 in the abrasive particles.

For retention, a vacuum generation system can be engaged after a majority (e.g., around 95%) of holes 810 of apparatus 800 are filled with abrasive particles. This results in the pressure inside housing 802 being decreased. Alternatively, the particles could be retained through activation of a magnet within housing 802. First major surface 804 can be positioned over substrate 104 and the retention system, whether it by a vacuum generation system or magnet system, is released, causing shaped abrasive particles 102, 300, 400, 500, 600, or 700 to contact substrate 104 and form the predetermined pattern thereon.

Following formation, bonded abrasive article precursor 100 can be used to form a bonded abrasive article. The bonded abrasive article can be formed by positioning bonded abrasive article precursor 100 within a mold; a binder material is then deposited to form a mixture of abrasive particles and binder material. One more additional bonded abrasive article precursor 100 can be placed in the mold, and additional binder material can be deposited in the mold. This can be used to create bonded abrasive articles having a plurality of abrasive layers of shaped abrasive particles. In some embodiments shaped abrasive particles 102, 300, 400, 500, 600, or 700 of adjacent abrasive layers can be directly aligned with each other. In other embodiments, shaped abrasive particles 102, 300, 400, 500, 600, or 700 of adjacent abrasive layers can be staggered with respect to each other; this can form a spiral pattern of shaped abrasive particles 102, 300, 400, 500, 600, or 700 in a resulting bonded abrasive article.

After the desired amount of bonded abrasive article precursors 100 are deposited in the mold, the mixture is cured by heating at, for example, temperatures ranging from about 70° C. to about 200° C. The mixture is heated for a sufficient time to cure the curable phenolic resins. For example, suitable times can range from about 2 hours to about 40 hours. Curing can also be done in a stepwise fashion; for example, the wheel can be heated to a first temperature ranging from about 70° C. to about 95° C. for a time ranging from about 2 hours to about 40 hours. The mixture can then be heated at a second temperature ranging from about 100° C. to about 125° C. for a time ranging from about 2 hours to about 40 hours. The mixture can then be heated at a third temperature ranging from about 140° C. to about 200° C. for a time ranging from about 2 hours to about 10 hours. The mixture can be cured in the presence of air. Alternatively, to help preserve any color, the wheel can be cured at a higher temperature (e.g., greater than 140° C.) under nitrogen, where the concentration of oxygen is relatively low.

Abrasive articles may be formed to have one of many shapes; for example, the wheel may have a shallow or flat dish or saucer shape with curved or straight flaring sides, and may have either a straight or depressed center portion encircling and adjacent to the central aperture (e.g., as in a Type 27 depressed center grinding wheel). As used herein, the term “straight center” is meant to include abrasive wheels other than depressed-center or raised-hub abrasive wheels, and those having front and back surfaces that continue without any deviation or sharp bends to the central aperture.

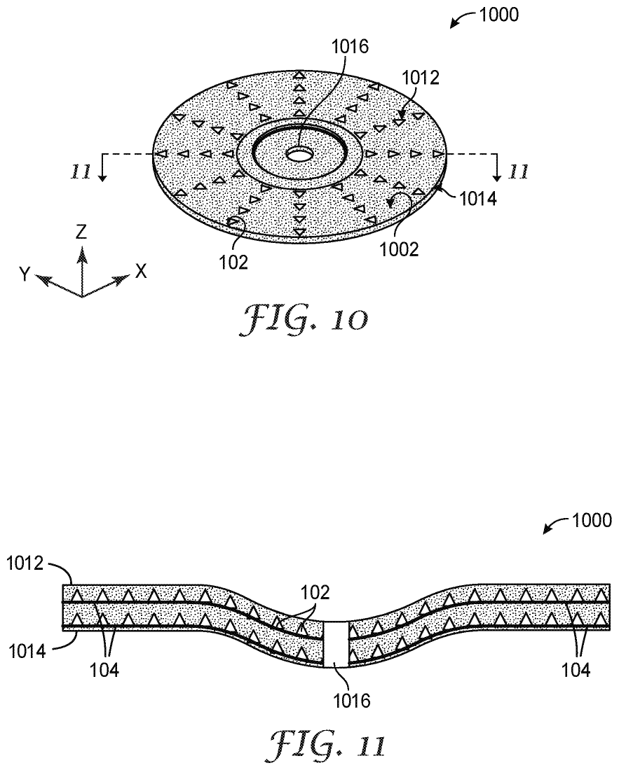

FIGS. 10 and 11 show an embodiment of bonded abrasive article 1000. Specifically FIG. 10 is a perspective view of abrasive article 1000 and FIG. 11 is a sectional view of abrasive article 1000 taken along line 2-2 of FIG. 10. FIGS. 10 and 11 show many of the same features and are discussed concurrently. As depicted, abrasive article 1000 is a depressed center grinding wheel. In other examples, the abrasive article can be a cut-off wheel, cutting wheel, a cut-and-grind wheel, a depressed center cut-off wheel, a reel grinding wheel, a mounted point, a tool grinding wheel, a roll grinding wheel, a hot-pressed grinding wheel, a face grinding wheel, a rail grinding wheel, a grinding cone, a grinding plug, a cup grinding wheel, a gear grinding wheel, a centerless grinding wheel, a cylindrical grinding wheel, an inner diameter grinding wheel, an outer diameter grinding wheel, or a double disk grinding wheel. The dimensions of the wheel can be any suitable size; for example the diameter can range from 2 mm to about 2000 mm.

Abrasive article 1000 includes first major surface 1002 and second major surface 1004. First major surface 1002 and second major surface 1004 have a substantially circular profile. Central aperture 1016 extends between first major surface 1002 and second major surface 1004 and can be used, for example, for attachment to a power-driven tool. In examples of other abrasive articles, central aperture 1016 can be designed to only extend partially between first and second major surfaces 1002 and 1004.

As shown, shaped abrasive particles 102 are attached to substrate 104 and arranged in layers. In some embodiments, substrate 104 may be degraded during curing, leaving only shaped abrasive particles 102. As shown in FIGS. 10 and 11, bonded abrasive article 1000 includes first layer of abrasive particles 1012 and second layer of abrasive particles 1014. First layer of abrasive particles 1012 and second layer of abrasive particles 1014 are spaced apart from one another with the binder located therebetween. Although two layers of abrasive particles 102 are shown, bonded abrasive article 1000 can include additional layers of abrasive particles. For example, bonded abrasive article 1000 can include a third layer of abrasive particles adjacent to at least one of first or second layers of abrasive particles 1012 and 1014.

As shown, at least a majority of the abrasive particles 102 are not randomly distributed within first and second layers 1012 and 1014. Rather, abrasive particles 102 are distributed according to a predetermined pattern. For example, FIG. 10 shows a pattern where adjacent abrasive particles 102 of first layer of abrasive particles 1012 are directly aligned with each other in rows extending from central aperture 1016 to the perimeter of bonded abrasive article 1000. The adjacent abrasive particles are also directly aligned in concentric circles. Adjacent layers can have the same or a different pattern. Additionally in some embodiments, abrasive particles 102 are randomly distributed.

First layer and second layer of abrasive particles 1012 and 1014, or any other layer of abrasive particles, can individually account for a different wt % of bonded abrasive article 1000. For example, the wt % of each layer can be selected from a value ranging from about 2 wt % to about 50 wt % of article 1000, or from about 10 wt % to about 40 wt %, or from about 15 wt % to about 35 wt %, or from about 25 wt % to about 30 wt %, or less than about, equal to about, or greater than about 5 wt %, 10, 15, 20, 25, 30, 35, 40, or 45 wt %.

Abrasive particles 102 in each layer do not have to be the same abrasive particle. For example, first layer of abrasive particles 1012 can include at least a first plurality of abrasive particles 102 and a second plurality of abrasive particles 102. The first plurality of abrasive particles 102 and the second plurality of abrasive particles 102 can individually range from about from about 10 wt % to about 100 wt % of the first layer of abrasive particles 1012, or from about 20 wt % to about 90 wt %, or from about 30 wt % to about 80 wt %, or from about 40 wt % to about 60 wt %, or less than about, equal to about, or greater than about 15 wt %, 20, 25, 30, 35, 40, 45, 50, 55, 60, 65, 70, 75, 80, 85, 90, or 95 wt %.

In still further embodiments, bonded abrasive article 1000 may only include first layer of abrasive particles 1012, but instead of being a planar layer, layer 1012 can conform to a helical shape centered about a z-axis and extending from first major surface 1002 to second surface 1004.

Abrasive particles 102 of the first and second pluralities of particles can differ in respect to the shape, size, or type of abrasive particle 102. For example, the first plurality of abrasive particles can be shaped abrasive particles whereas the second plurality of abrasive particles can be crushed abrasive particles. In other embodiments, the first and second pluralities of abrasive particles 102 can be a same type of abrasive particle 102 (e.g., a shaped abrasive particle) but may differ in size. In further embodiments, the first and second pluralities of particles may be different types of abrasive particles but may have substantially the same size. The second, third, and any additional layers of abrasive particles can include pluralities of abrasive particles that are similar to those of the first layer of abrasive particles.

Abrasive articles, according to the present disclosure, are useful, for example, as grinding wheels, including abrasives industry Type 27 (e.g., as in American National Standards Institute standard ANSI B7.1-2000 (2000) in section 1.4.14) depressed-center grinding wheels.

In use, a peripheral grinding edge of the front surface of a rotating abrasive wheel, according to the present disclosure, is secured to a rotating powered tool and brought into frictional contact with a surface of a workpiece and at least a portion of the surface is abraded. If used in such a manner, the abrasive performance of the abrasive article beneficially closely resembles the abrasive performance of a single layer construction wherein the shaped abrasive particles, and any optional diluent crushed abrasive particles, are distributed throughout the abrasive wheel.

Abrasive articles, according to the present disclosure, can be used dry or wet. During wet grinding, the article is used in conjunction with water, oil-based lubricants, or water-based lubricants. Abrasive articles according to the present disclosure may be particularly useful on various workpiece materials such as, for example, carbon steel sheet or bar stock and more exotic metals (e.g., high alloy steel or titanium), or on softer, more ferrous metals (e.g., mild steel, low alloy steels, or cast iron).

### EXAMPLES

Various embodiments of the present disclosure can be better understood by reference to the following Examples which are offered by way of illustration. The present disclosure is not limited to the Examples given herein.

TABLE 1
Materials

| ABBRE- | |
|---|---|
| VIATION | DESCRIPTION |
| SAP1 | Precisely-shaped alpha alumina abrasive particles |
| | prepared according to the disclosure of U.S. Pat. No. US |
| | 2015/0267097 Al (Rosenflanz et al.) by molding a slurry |
| | comprising non-colloidal solid particles and a liquid |
| | vehicle in equilateral triangular polypropylene mold |
| | cavities |
| DMAm | Dimethylacrylamide; CAS#: 2680-03-7 from TCI |
| | America |
| MAA | Methacrylic Acid; CAS#: 79-41-4 from Alfa Aesar |
| DMAPMAm | N-[3-(dimethylamino)propyl]-methacrylamide; CAS#: |
| | 2439-35-2 from TCI America |
| STG | Sodium Thioglycolate, CAS#: 367-51-1 from TCI |
| | America |
| V-50 | 2,2′-Azobis(2-methylpropionamidine)dihydrochloride; |
| | CAS#: 27776-21-2 from Wako Specialty Chemicals |
| 835 | Acusol 835; Water-based Acrylic Acid co-polymer |
| | dispersion; 28.75% solids by weight from The Dow |
| | Chemical Company, Midland, MI. |
| RP1 | Resole phenol-formaldehyde resin (75 wt. % in water), a |
| | 1.5:1 to 2.1:1 (phenol:formaldehyde) condensate |
| | catalyzed by 1 to 5% metal hydroxide from Georgia |
| | Pacific |
| PAF | Potassium aluminum fluoride from KBM Affilips Master |
| | Alloys, Delfzijl, Netherland |
| F400 | ZWSK F400 Fused White Aluminum Oxide from Imerys |
| | Fused Minerals |
| RP2 | liquid phenolic resin obtained as PREFERE 92 5136G1 |
| | from Dynea Erkner GmbH, Erkner, Germany |
| PP | A mixture of 39.4% of novolac phenolic resin (obtained |
| | as HEXION 0224P from Momentive Specialty Chemicals |
| | Columbus, Ohio), 8.2% of ZWSK F400 Fused White |
| | Aluminum Oxide (obtained from Imerys Fused Minerals), |
| | 0.4% of carbon black (obtained as LUVOMAXXX LB/S |
| | from Lehmann & Voss & Co. KG Hamburg, Germany), |
| | and 52.0% of PAF (potassium aluminum fluoride from |
| | KBM Affilips Master Alloys, Delfzijl, Netherlands) |
| SCRIM1 | Fiberglass mesh, obtained as “RXO 10-125 × 23 mm” |
| | from Rymatex Sp. Zo.o., Rymanów, Poland |
| SCRIM2 | Fiberglass mesh scrim attached to a cloth mesh, obtained |
| | as “RXV 10-125 × 23 mm” from Rymatex Sp. Zo.o, |
| | Rymanów, Poland |
| AP1 | 46FRSK brown fused alumina obtained from Treibacher |
| | Schleifmittel, Villach, Austria |
| AP2 | 60FRSK brown fused alumina obtained from Treibacher |
| | Schleifmittel, Villach, Austria |
| EAR | A radiation curable epoxy-acrylate resin as described in |
| | Example 2 of Shafer et al (WO2018106587A1) |
| ARCOL | Polyether polyol obtained from Bayer MaterialScience |
| LHT 240 | LLC, Pittsburgh, PA |
| EPON | Epoxy resin comprised of diglycidyether of bisphenol A |
| 1001F | obtained from Momentive Specialty Chemicals, Inc., |
| | Columbus, OH |
| EPONEX | Epoxy resin comprised of diglycidyether of hydrogenated |
| 1510 | bisphenol A obtained from Momentive Specialty |
| | Chemicals, Inc., Columbus, OH |
| LEVAPREN | Ethylene-vinyl acetate copolymer obtained from Lanxess |
| 700HV | Corporation, Pittsburgh, PA |
| PHENOXY | Phenoxy resin obtained from InChem Corporation, Rock |
| PKHA | Hill, SC |
| UVI6976 | Triaryl-sulfonium Hexafluoroantimonate, 50 wt % in |
| | propylene carbonate obtained from Aceto Port |
| | Washington, NY |
| GPTMS | 3-(Glycidoxypropyl) Trimethoxysilane obtained from |
| | UCT, Inc., Bristol, PA |
| BA | Butyl Acrylate obtained from BASF, Florham Park, NJ |
| IRGACURE | Benzyldimethyl ketal photoinitiator obtained from |
| 651 | BASF, Florham Park, NJ |
| IOTG | Isooctyl Thioglycolate obtained from Evans Chemetics |
| | LP |
| THFA | Tetrahydrofurfuryl acrylate (V-150) obtained from San |
| | Esters, New York City, NY |

### Pressure Sensitive Adhesive Preparation

### Acrylic Polymerization

A clean 500 mL reaction bottle was charged with 305.65 g deionized water, 39.65 g DMAm, 17.21 g MAA, 34.05 g DMAPMAm, 0.91 g STG, and 0.43 g of V-50. This mixture was purged with nitrogen for 20 minutes to remove dissolved oxygen. The reaction bottle was sealed and placed in a 50° C. preheated water bath with a tumbling mechanism and tumbled for 20 hours. Then the bottle was removed from the water bath. A 10-gram aliquot of the resulting viscous polymer solution was placed in an open-faced aluminum pan and dried in an oven at 120° C. under nitrogen gas purge for 24 hours. The polymer solution was found to be approximately 23.26% by weight dissolved solids.

### Phenolic-Copolymer Mixtures

Phenolic-copolymer mixtures were prepared in 4 oz. 70 mm diameter polypropylene straight walled jars (Taral Plastics, Union City, Calif.). Polymer solution, phenolic resin and fillers were massed into the cup and sealed with a screw cap. The cups were mixed in a Dual Asymmetric Centrifuge (DAC) SpeedMixer™ (FlackTek Inc., Landrum, S.C.) for 2 minutes at 2500 rpm and then allowed to remain at ambient temperature until all of the polymeric component dissolved. Once a homogeneous solution was achieved, the mixtures were mixed a second time at 2750 rpm for 2 minutes and stored in a refrigerator at 10° C. until use. Table 2 is a list of the mixtures produced.

TABLE 2
Curable Film Compositions

| Material | M1 | M2 | M3 |
|---|---|---|---|
| RP1 | 32.00 g | 32.00 g | 32.00 g |
| W³ #11 | | 28.64 g | 25.77 g |
| 835 | 13.00 g | | |
| PAF | 32.00 g | 24.00 g | |
| F400 | 4.00 g | 4.00 g | |

### Epoxy Acrylate Resin (EAR)

This resin was reproduced according to the description found at Example 2 of WO 2018106587A1 (Shafer). An acrylic copolymer was first prepared by the method of U.S. Pat. No. 5,804,610 (Hammer). Solutions were prepared by combining the acrylic monomers, radical photoinitiator (IRGACURE 651) and chain-transfer agent (IOTG) in an amber glass jar and swirling by hand to mix. The solution was divided into 25 g aliquots within heat sealed compartments of an ethylene vinyl acetate-based film, immersed in a 16° C. water bath, and polymerized using UV light (UVA=4.7 mW cm′, 270 J total exposure).

TABLE 3
Acrylic Copolymer Composition

| Material | (parts by wt.) |
|---|---|
| BA | 49 |
| THFA | 49 |
| IRGACURE 651 | 0.2 |
| IOTG | 0.1 |

To prepare a polymerizable epoxy-acrylate resin, composition, EAR, 32 pbw of the acrylate copolymer was transferred to a model ATR PLAST-CORDER mixer, from Brabender GmbH & Co. KG, Duisberg, Germany, and mixed at approximately 120° C. and 100 rpm for several minutes. To the mixer was added 19 pbw E-100 IF, 10 pbw LVPREN and 10 pbw PKHA, and the mixing continued for several minutes until homogeneous. 19 pbw E-1510, 10 pbw ARCOL and 1 pbw GPTMS were slowly added and mixing continued for several minutes until homogeneous. To this, 0.5 pbw UVI-6976 was slowly added, dropwise, and stirring continued for several minutes at 120° C. The mixture was then transferred to a silicone release liner and cooled to 21° C. Care was taken to minimize ambient light exposure of the finished sample.

### Probe Tack Measurements

The PSA compositions described herein were knife coated between two release coated polyester films at 80° C. to a thickness of 0.10±0.02 mm. Samples of each were cut to approximately 25.4 mm by 125 mm. The samples were transferred to stainless steel coupons for tack measurements. Measurements of tack before cure were conducted using a TA.XTplus texture analyzer (Stable Micro Systems, Godalming, Surrey, UK) equipped with a spherical stainless steel probe 1 cm in diameter, a linear motorized sample stage and two high-speed cameras. The probe was brought into contact with the samples at a rate of 0.1 mm/sec to a depth sufficient to produce 0.14 N of force. The probe was held at constant 0.14 N force for 5 seconds, then retracted from the sample at a rate of 5 mm/sec over a distance of 2 mm. Force and distance were recorded as a function of time. The measurement was repeated 5 times using a new region of the sample for each iteration. Contact diameter between the probe and film was measured optically using the high-speed video obtained during testing and the average for three measurements was used to calculate the contact area for each sample. The average peak force divided by the average contact area was taken to be the tack for each sample. The values are tabulated in Table 4 below:

TABLE 4

| | Probe Tack |
|---|---|
| | Peak Force |
| | (kPa) |
| M1 | 106 ± 7.9 |
| M2 | 110 ± 14.9 |
| M3 | 72.1 ± 35.0 |
| EAR | 300 ± 27.6 |

### SCRIM Preparation

Compositions were hot-knife coated at 90° C. between two 6 inch wide poly(ethylene terephthalate) release liners to a thickness of 0.10 mm (0.004 in.). One liner was removed, and SCRIM1 was placed on the coated resin. The release liner was laminated back onto the film with scrim with a 2-inch rubber roller and trimmed to size. SCRIM1 coated with M1 is referred to as SCRIM1-M1. SCRIM1 coated with M2 is referred to as SCRIM1-M2. SCRIM1 coated with M3 is referred to as SCRIM1-M3. The process was repeated on SCRIM2 to create SCRIM2-M1, SCRIM2-M2, and SCRIM2-M3. A third set of scrims was prepared as above using a UV-curable adhesive composition EAR. The scrims treated with EAR are denoted SCRIM1-EAR and SCRIM2-EAR.

### Cutting Test Method

A 40-inch (1 m) long sheet of ⅛ inch (3.2 mm) thick stainless steel was secured with its major surface inclined at a 35-degree angle relative to horizontal. A guide rail was secured along the downward-sloping top surface of the inclined sheet. A DeWalt Model D28114 4.5-inch (11.4-cm)/5-inch (12.7-cm) cut-off wheel angle grinder was secured to the guide rail such that the tool was guided in a downward path under the force of gravity. A cut-off wheel for evaluation was mounted on the tool such that the cut-off wheel encountered the full thickness of the stainless steel sheet when the cut-off wheel tool was released to traverse downward, along the rail under gravitational force. The cut-off wheel tool was activated to rotate the cut-off wheel at 10,000 rpm, the tool was released to begin its descent, and the length of the resulting cut in the stainless steel sheet was measured after 60 seconds. Dimensions of the cut-off wheel were measured before and after the cutting test to determine wear.

### Example 1

RP (56.5 g) mixture was added to 650 grams of SAP and was mixed in a KitchenAid Commercial mixer (Professional 5 Plus Model). This mixture was then combined with 300 grams of PP in a KitchenAid Commercial mixer (Professional 5 Plus Model). The resulting mix was then sieved using 16-mesh and 30-mesh screens (+16/−30) to isolate the particulate binder-coated shaped abrasive particles.

A positioning tool having horizontal triangular-shaped cavities of dimensions 0.075 inch (1.9 mm) long with sidewall angles of 98 degrees relative to the bottom of each cavity, and a mold cavity depth of 0.0138 inch (0.35 mm) arranged in a radial array (all apexes pointing toward the perimeter), was then filled with the particulate binder-coated shaped abrasive particles assisted by tapping. Shaped abrasive particles in excess of those accommodated into the tool's cavities were removed by brushing and shaking.

The shaped abrasive particle-containing tool was then brought into contact with the adhesive coated fiberglass SCRIM1-M1 and inverted to deposit the shaped abrasive particles in a precisely arranged and oriented pattern on the adhesive coated disc. A total of 3.5 grams (g) of resin-coated SAP were applied. Resin-coated SAP were deposited on SCRIM2-M1 in the same manner.

SCRIM2-M1 with SAP was placed in the bottom of a 5-inch (127-mm) diameter×1-inch (2.5-cm) deep metal mold cavity, coated side up. The mold had an inner diameter of 23-mm. A fill mixture (36.5 g) (made from a masterbatch of 650 grams of API, 55 grams of RP and 295 grams of PP) was then placed on top of the coated scrim. SCRIM2-M1 was then placed on top of the fill mixture, coated side down. A 70 mm diameter paper label was added on top of SCRIM2-M1. A metal flange 28 mm×22.45 mm×1.2 mm from Lumet PPUH in Jaslo, Poland, was placed on top of the label. The mold was closed and the coated scrim-fill-coated scrim sandwich was pressed at a load of 50 tons (907 kg) at room temperature for 2 sec. The cut-off wheel precursor was then removed from the mold and cured in a stack with a 30 hour (hr) cure cycle: 2 hrs at 75° C., 2 hrs at 90° C., 5 hrs at 110° C., 3 hrs at 135° C., 3 hrs at 188° C., 13 hrs at 188° C., and a then 2 hrs cool down to 60° C. Two replicates of Example 1 were made for a total of three wheels.

### Example 2

Example 1 was repeated, except that SAP grain on SCRIM1-M1 and SCRIM2-M1 is not coated in RP or PP.

### Comparative Example A

RP (58 g) mixture was added to 650 grams of SAP and was mixed in a KitchenAid Commercial mixer (Professional 5 Plus Model). This mixture was then combined with 300 grams of PP in a KitchenAid Commercial mixer (Professional 5 Plus Model). The resulting mix was then sieved using 16-mesh and 30-mesh screens (+16/−30) to isolate the particulate binder-coated shaped abrasive particles.

Example 1 was repeated, except that no shaped abrasive particles were placed on either SCRIM1-M1 or SCRIM2-M1, and the fill mixture was 26 grams of a mixture of 650 grams of API, 55 grams of RP and 295 grams of PP combined with 4.4 g of isolated resin-coated SAP. Two replicates of Comparative Example A were made for a total of three samples.

### Comparative Example B

Comparative Example A was repeated, except that SAP grain on SCRIM1-M1 and SCRIM2-M1 is not coated in not RP or PP.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

### Additional Embodiments

The following exemplary embodiments are provided, the numbering of which is not to be construed as designating levels of importance:

Embodiment 1 provides a bonded abrasive article precursor comprising:
an abrasive layer comprising a plurality of shaped abrasive particles disposed on an adhesive and forming a predetermined pattern.

Embodiment 2 provides the bonded abrasive article of Embodiment 1, further comprising a backing having the abrasive layer adhered thereto by the adhesive.

Embodiment 3 provides the bonded abrasive article precursor of Embodiment 2, wherein the backing comprises a polymeric film, a metal foil, a woven fabric, a knitted fabric, paper, a vulcanized fiber, a non-woven, a foam, a screen, a laminate, a fibrous web, or a combination thereof.

Embodiment 4 provides the bonded abrasive article precursor of Embodiment 3, wherein the fibrous web comprises a plurality of fibers forming a non-woven web, a spun-bound non-woven web, a needle-entangled non-woven web, a braided web, a knit web, a woven web, a blown microfiber, or a combination thereof.

Embodiment 5 provides the bonded abrasive article precursor of any one of Embodiments 3 or 4, wherein the fibrous web comprises a yarn comprising a plurality of the fibers.

Embodiment 6 provides the bonded abrasive article precursor of any one of Embodiments 3-5, wherein the adhesive is disposed on individual fibers of the reinforcing component.

Embodiment 7 provides the bonded abrasive article precursor of any one of Embodiments 3-6, wherein the fibrous web comprises glass fibers.

Embodiment 8 provides the bonded abrasive article precursor of any one of Embodiments 1-7, wherein at least one of the shaped abrasive particles of the plurality of shaped abrasive particles is tetrahedral and comprises four faces joined by six edges terminating at four tips, each one of the four faces contacting three of the four faces.

Embodiment 9 provides the bonded abrasive article precursor of Embodiment 8, wherein at least one of the four faces is substantially planar.

Embodiment 10 provides the bonded abrasive article precursor of any one of Embodiments 8 or 9, wherein at least one of the four faces is concave.

Embodiment 11 provides the bonded abrasive article precursor of Embodiment 8, wherein all of the four faces are concave.

Embodiment 12 provides the bonded abrasive article precursor of any one of Embodiments 8-10, wherein at least one of the four faces is convex.

Embodiment 13 provides the bonded abrasive article precursor of Embodiment 8, wherein all of the four faces are convex.

Embodiment 14 provides the bonded abrasive article precursor of any one of Embodiments 8-13, wherein at least one of the tetrahedral abrasive particles has equal-sized edges.

Embodiment 15 provides the bonded abrasive article precursor of any one of Embodiments 8-14, wherein at least one of the tetrahedral abrasive particles has different-sized edges.

Embodiment 16 provides the bonded abrasive article precursor of any one of Embodiments 1-15, wherein at least one of the shaped abrasive particles of the plurality of shaped abrasive particles comprises a first side and a second side separated by a thickness t, the first side comprises a first face having a triangular perimeter and the second side comprises a second face having a triangular perimeter, wherein the thickness t is equal to or smaller than the length of the shortest side-related dimension of the particle.

Embodiment 17 provides the bonded abrasive article precursor of Embodiment 16, further comprising at least one sidewall connecting the first side and the second side.

Embodiment 18 provides the bonded abrasive article precursor of Embodiment 17, wherein the at least one sidewall is a sloping sidewall.

Embodiment 19 provides the bonded abrasive article precursor of any one of Embodiments 17 or 18, wherein a draft angle α of the sloping sidewall is in a range of from about 95 degrees and about 130 degrees.

Embodiment 20 provides the bonded abrasive article precursor of any one of Embodiments 16-19, wherein the first face and the second face are substantially parallel to each other.

Embodiment 21 provides the bonded abrasive article precursor of any one of Embodiments 16-20, wherein the first face and the second face are substantially non-parallel to each other.

Embodiment 22 provides the bonded abrasive article precursor of any one of Embodiments 16-21, wherein at least one of the first and the second face are substantially planar.

Embodiment 23 provides the bonded abrasive article precursor of any one of Embodiments 16-22 wherein at least one of the first and the second face is non-planar.

Embodiment 24 provides the bonded abrasive article precursor of any one of Embodiments 1-23 wherein one or more of the shaped abrasive particles comprises a cylindrical body extending between circular first and second ends.

Embodiment 25 provides the bonded abrasive article precursor of any one of Embodiments 1-24, wherein at least one of the shaped abrasive particles comprises an opening, a concave surface, a convex surface, a groove, a ridge, a fractured surface, a low roundness factor, a perimeter comprising one or more corner points having a sharp tip, or a combination thereof.

Embodiment 26 provides the bonded abrasive article precursor of any one of Embodiments 1-25, wherein the predetermined pattern comprises a plurality of circles.

Embodiment 27 provides the bonded abrasive article precursor of any one of Embodiments 1-26, wherein the predetermined pattern comprises a plurality of substantially parallel lines.

Embodiment 28 provides the bonded abrasive article precursor of any one of Embodiments 1-27, wherein a z-direction rotational angle about a line perpendicular to a major surface of the backing and passing through individual shaped abrasive particles of the plurality of shaped abrasive particles is substantially the same for at least a portion of the plurality of shaped abrasive particles.

Embodiment 29 provides the bonded abrasive article precursor of Embodiment 28, wherein the portion of the shaped abrasive particles having substantially the same z-direction rotational angle are in a range of from about 25 wt % to about 100 wt % of the plurality of shaped abrasive particles.

Embodiment 30 provides the bonded abrasive article precursor of any one of Embodiments 28 or 29, wherein the portion of the shaped abrasive particles having substantially the same z-direction rotational angle are in a range of from about 50 wt % to about 80 wt % of the plurality of shaped abrasive particles.

Embodiment 31 provides the bonded abrasive article precursor of any one of Embodiments 1-30, wherein at least some of the plurality of shaped abrasive particles comprise a ceramic material, a polymeric material, or a mixture thereof.

Embodiment 32 provides the bonded abrasive article precursor of any one of Embodiments 1-31, wherein at least some of the plurality of shaped abrasive particles comprise alpha alumina, sol-gel-derived alpha alumina, or a mixture thereof.

Embodiment 33 provides the bonded abrasive article precursor of any one of Embodiments 1-32, wherein at least some of the plurality of shaped abrasive particles comprise an aluminosilicate, an alumina, a silica, a silicon nitride, a carbon, a glass, a metal, an alumina-phosphorous pentoxide, an alumina-boria-silica, a zirconia, a zirconia-alumina, a zirconia-silica, a fused aluminum oxide, a heat-treated aluminum oxide, a ceramic aluminum oxide, a sintered aluminum oxide, a silicon carbide material, titanium diboride, boron carbide, tungsten carbide, titanium carbide, diamond, cubic boron nitride, garnet, fused alumina-zirconia, cerium oxide, zirconium oxide, titanium oxide, or a combination thereof.

Embodiment 34 provides the bonded abrasive article precursor of any one of Embodiments 1-33, wherein the adhesive comprises a thermoplastic resin, a thermoset resin, or a radiation curable resin.

Embodiment 35 provides the bonded abrasive article precursor of Embodiment 34, wherein the thermoplastic resin comprises an acrylic adhesive, a rubber adhesive, a silicone adhesive, a styrene block copolymer adhesive, a polyvinyl ether-based adhesive, or a mixture thereof.

Embodiment 36 provides the bonded abrasive article precursor of Embodiment 35, wherein the acrylic adhesive comprises a poly((meth)acrylate).

Embodiment 37 provides the bonded abrasive article precursor of any one of Embodiments 35 or 36, wherein the rubber adhesive comprises a natural rubber, a synthetic rubber, or a mixture thereof.

Embodiment 38 provides the bonded abrasive article precursor of any one of Embodiments 34-37, wherein the thermoset resin comprises an epoxy resin, a phenol-formaldehyde resin, or a mixture thereof.

Embodiment 39 provides the bonded abrasive article precursor of Embodiment 38, wherein the epoxy resin comprises one or more epoxy resins chosen from a diglycidyl ether of bisphenol F, a low epoxy equivalent weight diglycidyl ether of bisphenol A, a liquid epoxy novolac, a liquid aliphatic epoxy, a liquid cycloaliphatic epoxy, a 1,4-cyclohexandimethanoldiglycidylether, 3,4-epoxycyclohexylmethyl-3,4-epoxycyclohexane carboxylate, tetraglycidylmethylenedianiline, N,N,N′,N′-tetraglycidyl-4,4′-methylenebisbenzenamine, a triglycidyl of para-aminophenol, N,N,N′,N′-tetraglycidyl-m-xylenediamine, an acrylate epoxy resin, and a mixture thereof.

Embodiment 40 provides the bonded abrasive article precursor of Embodiment 39, wherein the acrylated epoxy resin comprises:
a tetrahydrofurfuryl (THF) (meth)acrylate copolymer component;
one or more of the epoxy resins; and
one or more hydroxy-functional polyethers.

Embodiment 41 provides the bonded abrasive article precursor of Embodiment 40, wherein the THF (meth)acrylate copolymer component comprises one or more THF (meth)acrylate monomers, one or more Ci-Cs (meth)acrylate ester monomers, and one or more optional cationically reactive functional (meth)acrylate monomers.

Embodiment 42 provides the bonded abrasive article precursor of any one of Embodiments 40 or 41, wherein the THF (meth)acrylate copolymer component comprises:
(A) 40-60 wt % of tetrahydrofurfuryl (meth)acrylate monomers;
(B) 40-60 wt % of Ci-Cs alkyl (meth)acrylate ester monomers; and
(C) 0-10 wt % of cationically reactive functional monomers, wherein the sum of (A), (B), and (C) is 100 wt % of the THF (meth)acrylate copolymer.

Embodiment 43 provides the bonded abrasive article precursor of any one of Embodiments 40-42, wherein the curable composition comprises: i) from about 15 to about 50 parts by weight of the THF (meth)acrylate copolymer component; ii) from about 25 to about 50 parts by weight of the one or more epoxy resins; iii) from about 5 to about 15 parts by weight of the one or more hydroxy-functional polyethers; iv) from about 10 to about 25 parts by weight of one or more hydroxyl-containing film-forming polymers; where the sum of i) to iv) is 100 parts by weight; and v) from about 0.1 to about 5 parts by weight of a photoinitiator, relative to the 100 parts of i) to iv).

Embodiment 44 provides the bonded abrasive article precursor of any one of Embodiments 33-43, wherein the thermoset resin comprises a hydrogenated polybutadiene, a polytetramethylene ether glycol, a copolymer of isooctyl acrylate and acrylic acid, an aliphatic zwitterionic amphiphilic acrylic polymer, a phenolic resin, a urea-formaldehyde resin, an aminoplast resin, a melamine resin, a urethane resin, or mixtures thereof.

Embodiment 45 provides a bonded abrasive article comprising:
a first major surface and an opposed second major surface each contacting a peripheral side surface and extending in an x-y-direction;
a central axis extending through the first and second major surfaces in a z-direction;
the bonded abrasive article precursor of any one of Embodiments 1-44; and
a binder material retaining the layer of abrasive particles.

Embodiment 46 provides the bonded abrasive article of Embodiment 45, wherein the first major surface and the second major surface have a substantially circular profile.

Embodiment 47 provides the bonded abrasive article of any one of Embodiments 45 or 46, further comprising a central aperture extending at least partially between the first and second major surfaces.

Embodiment 48 provides the bonded abrasive article of Embodiment 47, wherein the central axis extends through the central aperture.

Embodiment 49 provides the bonded abrasive article of any one of Embodiments 45-48, wherein the layer of abrasive particles is a first layer of abrasive particles and the abrasive article further comprises a second layer of abrasive particles attached to a an adhesive and spaced apart from the first layer of shaped abrasive particles in the z-direction.

Embodiment 50 provides the bonded abrasive article of Embodiment 49, wherein the predetermined pattern of the first and second layers of abrasive particles is substantially the same.

Embodiment 51 provides the bonded abrasive article of any one of Embodiments 49 or 50, wherein the shaped abrasive particles of the first layer and the shaped abrasive particles of the second layer are staggered with respect to each other.

Embodiment 52 provides the bonded abrasive article of Embodiment 51, wherein the plurality of shaped abrasive particles of the first layer, the second layer, or both are encapsulated by the binder material.

Embodiment 53 provides the bonded abrasive article of any one of Embodiments 51 or 52, wherein the first layer of the plurality of shaped abrasive particles, the second layer of abrasive particles, or both, independently range from about 2 wt % to about 50 wt % of the abrasive article.

Embodiment 54 provides the bonded abrasive article of any one of Embodiments 51-53, wherein the first layer of the plurality of shaped abrasive particles, the second layer of abrasive particles, or both, independently range from about 25 wt % to about 30 wt % of the abrasive article.

Embodiment 55 provides the bonded abrasive article of any one of Embodiments 45-54, wherein the bonded abrasive article further comprises a plurality of crushed abrasive particles.

Embodiment 56 provides the bonded abrasive article of Embodiment 55, wherein the crushed abrasive particles range from about 10 wt % to about 95 wt % of the bonded abrasive article.

Embodiment 57 provides the bonded abrasive article of any one of Embodiments 55 or 56, wherein the crushed abrasive particles range from about 20 wt % to about 50 wt % of the bonded abrasive article.

Embodiment 58 provides the bonded abrasive article of any one of Embodiments 55-57, wherein a size of individual shaped abrasive particles of the plurality of abrasive particles of the first plurality of abrasive layer is different than a size of individual shaped abrasive particles of the shaped abrasive particles of the second layer of shaped abrasive particles.

Embodiment 59 provides the bonded abrasive article of any one of Embodiments 45-58 wherein the binder material comprises an organic binder, a vitrified binder, a metallic binder, or a mixture thereof.

Embodiment 60 provides the bonded abrasive article of Embodiment 59, wherein the organic binder comprises a phenolic resin.

Embodiment 61 provides the bonded abrasive article of any one of Embodiments 45-60, wherein the abrasive article is at least one of a cut-off wheel, a cut-and-grind wheel, a depressed center grinding wheel, a depressed center cut-off wheel, a reel grinding wheel, a mounted point, a tool grinding wheel, a roll grinding wheel, a hot-pressed grinding wheel, a face grinding wheel, a rail grinding wheel, a grinding cone, a grinding plug, a cup grinding wheel, a gear grinding wheel, a centerless grinding wheel, a cylindrical grinding wheel, an inner diameter grinding wheel, an outer diameter grinding wheel, and a double disk grinding wheel.

Embodiment 62 provides the bonded abrasive article of any one of Embodiments 45-61, wherein a diameter of the bonded abrasive article is in a range of from about 2 mm to about 2000 mm.

Embodiment 63 provides the bonded abrasive article of any one of Embodiments 45-62, wherein a diameter of the bonded abrasive article is in a range of from about 100 mm to about 1000 mm.

Embodiment 64 provides a method of making the bonded abrasive article precursor of any one of Embodiments 1-63, the method comprising:
contacting the plurality of shaped abrasive particles with the adhesive.

Embodiment 65 provides the method of Embodiment 64, wherein the plurality of shaped abrasive particles are retained in individual cavities of a production tool before contacting the adhesive with the plurality of shaped abrasive particles.

Embodiment 66 provides the method of Embodiment 65, wherein the individual shaped abrasive particles are retained in the individual cavities via a vacuum, an electrostatic interaction, engagement with a retaining member, or a combination thereof.

Embodiment 67 provides the method of Embodiment 66, wherein the individual shaped abrasive particles are released from the production tool by releasing the vacuum, changing the electrostatic interaction, disengaging the retaining member, or a combination thereof.

Embodiment 68 provides the method of any one of Embodiments 65-67, wherein the cavities together have a pattern that substantially corresponds to the predetermined pattern of the individual shaped abrasive particles.

Embodiment 69 provides a method of forming the bonded abrasive article of any one of Embodiments 45-63, the method comprising:
positioning the bonded abrasive article precursor of any one of Embodiments 1-44 or formed according to the method of any one of Embodiments 64-68 at least partially within a mold;
depositing a binder material in the mold; and
pressing the binder material.

Embodiment 70 provides the method of Embodiment 69, further comprising heating the mold.

Embodiment 71 provides the method of any one of Embodiments 69 or 70, wherein the bonded abrasive article precursor is a first bonded abrasive article precursor and the method further comprises positioning a second bonded abrasive article precursor at least partially within the mold.

Embodiment 72 provides a method of using the abrasive article of Embodiment 1, comprising:
moving the abrasive article with respect to a surface contacted therewith, to abrade the surface.

1. A bonded abrasive article precursor comprising:
an abrasive layer comprising a plurality of shaped abrasive particles disposed on an adhesive and forming a predetermined pattern.

2. The bonded abrasive article of claim 1, further comprising a backing having the abrasive layer adhered thereto by the adhesive.

3. The bonded abrasive article precursor of claim 2, wherein the backing comprises a polymeric film, a metal foil, a woven fabric, a knitted fabric, paper, a vulcanized fiber, a non-woven, a foam, a screen, a laminate, a fibrous web, or a combination thereof.

4. The bonded abrasive article precursor of claim 1, wherein a z-direction rotational angle about a line perpendicular to a major surface of the backing and passing through individual shaped abrasive particles of the plurality of shaped abrasive particles is substantially the same for at least a portion of the plurality of shaped abrasive particles.

5. The bonded abrasive article precursor of claim 1, wherein at least some of the plurality of shaped abrasive particles comprise a ceramic material, a polymeric material, or a mixture thereof.

6. The bonded abrasive article precursor of claim 1, wherein the adhesive comprises a thermoplastic resin, a thermoset resin, a radiation curable resin, or a mixture thereof.

7. A bonded abrasive article comprising:
a first major surface and an opposed second major surface each contacting a peripheral side surface and extending in an x-y-direction;
a central axis extending through the first and second major surfaces in a z-direction;
the bonded abrasive article precursor of claim 1; and
a binder material retaining the abrasive particles.

8. The bonded abrasive article of claim 7, wherein the first major surface and the second major surface have a substantially circular profile.

9. The bonded abrasive article of claim 8, wherein the layer of abrasive particles is a first layer of abrasive particles and the abrasive article further comprises a second layer of abrasive particles disposed on an adhesive and spaced apart from the first layer of shaped abrasive particles in the z-direction.

10. The bonded abrasive article of claim 9, wherein a predetermined pattern of the first and second layers of abrasive particles is substantially the same.

11. A method of making the bonded abrasive article precursor of claim 1, the method comprising:
contacting the plurality of shaped abrasive particles with the adhesive.

12. The method of claim 11, wherein the plurality of shaped abrasive particles are retained in individual cavities of a production tool before contacting the adhesive with the plurality of shaped abrasive particles.

13. The method of claim 12, wherein the individual shaped abrasive particles are retained in the individual cavities via a vacuum, an electrostatic interaction, engagement with a retaining member, or a combination thereof.

14. The method of claim 13, wherein the individual shaped abrasive particles are released from the production tool by releasing the vacuum, changing the electrostatic interaction, disengaging the retaining member, or a combination thereof.

15. The method of claim 14, wherein the cavities together have a pattern that substantially corresponds to a predetermined pattern of the individual shaped abrasive particles.
